(19) United States
(12) Patent Application Publication
(10) Pub. No.: US 2026/0049264 A1
(43) Pub. Date: Feb. 19, 2026

(54) CHEMICAL SOLUTION AND CHEMICAL SOLUTION-HOUSING ARTICLE

(71) Applicant: FUJIFILM Corporation, Tokyo (JP)

(72) Inventors: Akihiko Ohtsu, Shizuoka (JP); Tetsuya Kamimura, Shizuoka (JP); Ryo Saito, Shizuoka (JP); Yoshiharu Togawa, Shizuoka (JP)

(21) Appl. No.: 19/367,060

(22) Filed: Oct. 23, 2025

Related U.S. Application Data
(63) Continuation of application No. PCT/JP2024/016806, filed on May 1, 2024.

(30) Foreign Application Priority Data
May 16, 2023 (JP) 2023-080513

(51) Int. Cl. C11D 7/50

(52) U.S. Cl. CPC C11D 7/5022

(57) ABSTRACT

It is an object of the invention to provide a chemical solution that ensures good in-plane cleanliness uniformity on a substrate and good wafer bevel cleanliness and exhibits high capability of preventing the occurrence of defects on the substrate upon contact with the substrate. It is another object of the invention to provide a chemical solution-housing article that houses the chemical solution. The chemical solution of the invention contains 2-heptanone, water, and a carbonyl compound having 6 to 8 carbon atoms other than 2-heptanone. The content of 2-heptanone is 60% by mass or more based on the total mass of the chemical solution, and the content of water is 1 to 1000 ppm by mass based on the total mass of the chemical solution. A P value determined from formula (1) is 3 to 10. P=−log₁₀ (X×Y) formula (1). Here, X is the numerical value X when the concentration of water in the chemical solution is denoted by X mol/L, and Y is the numerical value Y when the concentration of the carbonyl compound in the chemical solution is denoted by Y mol/L.

### CROSS-REFERENCE TO RELATED APPLICATIONS

This application is a Continuation of PCT International Application No. PCT/JP2024/016806 filed on May 1, 2024, which claims priority under 35 U.S.C. § 119 (a) to Japanese Patent Application No. 2023-080513 filed on May 16, 2023. The above applications are hereby expressly incorporated by reference, in their entirety, into the present application.

### BACKGROUND OF THE INVENTION

### 1. Field of the Invention

The present invention relates to a chemical solution and a chemical solution-housing article.

### 2. Description of the Related Art

Conventional processes for producing semiconductor devices such as ICs (Integrated Circuits) and LSI (Large Scale Integrated) circuits involve lithographic microfabrication using a photoresist composition. In recent years, as the degree of integration of integrated circuits has increased, there has been a growing demand for ultra-fine pattern formation in the sub-micron or quarter-micron range. Accordingly, the wavelength of exposure light tends to be shortened. Specifically, the g-line is replaced by the i-line and further by KrF excimer laser light. Moreover, at present, in addition to the use of excimer laser light, lithography using electron beams, X-rays, EUV (extreme ultraviolet) rays, etc. is being developed.

In the lithography described above, a film (resist film) is formed using an actinic ray-sensitive or radiation-sensitive composition (which is referred to also as a “resist composition”), and then the obtained film is subjected to the following treatment. Specifically, the film is exposed to light and developed using a developer, and the developed film is washed with a rinsing liquid.

As the developer used for the lithography described above, JP2022-526031A, for example, discloses a developer composition used for developing treatment for an organometallic patterning layer. This developer composition contains a solvent having a value of Hansen solubility parameters δH+δP of about 16 (J/cm³)^{1/2} or less in an amount of at least 55% by volume and a solvent having a value of Hansen solubility parameters δH+δP of about 16 (J/cm³)^{1/2} in an amount of at least 0.25 to 45% by volume.

### SUMMARY OF THE INVENTION

The present inventors have conducted studies on chemical solutions used for a semiconductor substrate production process, in particular a chemical solution used as a washing liquid, a developer, a rinsing liquid, or a pre-wetting liquid in a semiconductor substrate production process including the step of forming a metal resist film using a metal resist composition, with reference made to JP2022-526031A. The inventors have found that there is room for further improvement in cleanliness of surface regions of a substrate treated with the chemical solution, the capability of preventing the occurrence of defects, etc.

The present invention has been made in view of the above circumstances, and it is an object to provide a chemical solution that ensures good in-plane uniformity of cleanliness on a substrate and good wafer bevel cleanliness and exhibits high capability of preventing the occurrence of defects on the substrate upon contact with the substrate.

Another object of the invention is to provide a chemical solution-housing article that houses the chemical solution.

The inventors have conducted extensive studies to solve the foregoing problem and found that the problem can be solved by the following aspects.
[1] A chemical solution including 2-heptanone, water, and a carbonyl compound having 6 to 8 carbon atoms other than 2-heptanone, wherein a content of the 2-heptanone is 60% by mass or more based on a total mass of the chemical solution, wherein a content of the water is 1 to 1000 ppm by mass based on the total mass of the chemical solution, and wherein a P value determined from formula (1) described later is 3 to 10.
[2] The chemical solution according to [1], wherein the content of the water is 1 to 100 ppm by mass based on the total mass of the chemical solution.
[3] The chemical solution according to [1] or [2], wherein a content of the carbonyl compound is 0.1 to 1000 ppm by mass based on the total mass of the chemical solution.
[4] The chemical solution according to any of [1] to [3], wherein the carbonyl compound includes a ketone having 6 to 8 carbon atoms other than 2-heptanone.
[5] The chemical solution according to any of [1] to [4], wherein the carbonyl compound includes two or more ketones having 6 to 8 carbon atoms other than 2-heptanone.
[6] The chemical solution according to any of [1] to [5], wherein the carbonyl compound includes at least one selected from the group consisting of 5-methyl-2-hexanone and 4-heptanone.
[7] The chemical solution according to any of [1] to [6], wherein the carbonyl compound includes a carbonyl compound represented by a chemical formula C7H140.
[8] The chemical solution according to any of [1] to [7], wherein the carbonyl compound includes a ketone having 6 to 8 carbon atoms other than 2-heptanone and an aldehyde having 6 to 8 carbon atoms, and wherein a ratio of a content of the aldehyde to a content of the ketone is 1.0×10⁻⁵ to 1.0×10².
[9] The chemical solution according to any of [1] to [8], further including a cycloalkane compound having 8 to 12 carbon atoms and having a boiling point of 160° C. or higher, wherein a content of the cycloalkane compound is 0.1 to 1000 ppm by mass based on the total mass of the chemical solution.

The chemical solution according to [9], wherein the cycloalkane compound includes at least one selected from the group consisting of 1-methyl-2-isopropylcyclohexane, 1-methyl-3-isopropylcyclohexane, and 1-methyl-4-isopropylcyclohexane.

The chemical solution according to [9] or [10], wherein the cycloalkane compound includes 1-methyl-4-isopropylcyclohexane.

The chemical solution according to any of [1] to [11], further including Mn atoms, wherein a content of the Mn atoms is 0.001 to 10 ppt by mass based on the total mass of the chemical solution.

The chemical solution according to any of [1] to [12], further including Mn atoms and Fe atoms, wherein a ratio of a content of the Mn atoms to a content of the Fe atoms is 1.0×10-3 to 1.0.

The chemical solution according to any of [1] to [13], wherein the chemical solution is used as at least one selected from the group consisting of a washing liquid, a developer, a pre-wetting liquid, and a rinsing liquid.

The chemical solution according to any of [1] to [14], wherein the chemical solution is used as at least one selected from the group consisting of a pre-wetting liquid, a rinsing liquid, a washing liquid, and a developer in a semiconductor substrate production process including the step of forming a metal resist film.

A chemical solution-housing article including: a container; and the chemical

solution according to any one of [1] to [15], the chemical solution being housed in the container.

The chemical solution-housing article according to [16], wherein the container has a liquid-contacting portion that is in contact with the chemical solution and that is formed of a nonmetallic material or stainless steel.

The chemical solution-housing article according to or [17], wherein the nonmetallic material is at least one selected from the group consisting of polyethylene resins, polypropylene resins, polyethylene-polypropylene resins, tetrafluoroethylene resins, tetrafluoroethylene-perfluoroalkyl vinyl ether copolymers, tetrafluoroethylene-hexafluoropropylene copolymer resins, tetrafluoroethylene-ethylene copolymer resins, chlorotrifluoroethylene-ethylene copolymer resins, vinylidene fluoride resins, chlorotrifluoroethylene copolymer resins, and vinyl fluoride resins.

The present invention can provide a chemical solution that ensures good in-plane cleanliness uniformity on a substrate and good wafer bevel cleanliness and exhibits high capability of preventing the occurrence of defects on the substrate upon contact with the substrate.

The present invention can also provide a chemical solution-housing article that houses the chemical solution.

### DESCRIPTION OF THE PREFERRED EMBODIMENTS

The present invention will next be described in detail.

The structural requirements described below may be described on the basis of representative embodiments of the present invention. However, the invention is not limited to these embodiments.

In the present specification, a numerical range represented using “to” means a range including the numerical values before and after the “to” as the lower limit and the upper limit, respectively.

In the present specification, “actinic rays” or “radiation” means, for example, an emission line spectrum of a mercury lamp, far-ultraviolet rays typified by excimer laser light, extreme ultraviolet light (EUV light), X-rays, electron beams (EB), etc. In the present specification, “light” means actinic rays or radiation.

In the present specification, “exposure to light” is intended to encompass not only exposure to an emission line spectrum of a mercury lamp, far-ultraviolet rays typified by excimer laser light, X-rays, EUV light, etc. but also image drawing using an electron beam or a particle beam such as an ion beam.

A substituent is preferably a monovalent substituent unless otherwise specified.

In the present specification, no limitation is imposed on the bonding direction of a divalent group, unless otherwise specified. For example, when Y in a compound represented by a formula “X—Y—Z” is —COO—, Y may be —CO—O— or may be —O—CO—. This compound may be “X—CO—O—Z” or may be “X—O—CO—Z.”

In the present specification, a halogen atom is, for example, a fluorine atom, a chlorine atom, a bromine atom, or an iodine atom.

In the present specification, solids mean components forming a metal resist film and do not include a solvent (such as an organic solvent or water). Any component included in a metal resist film is regarded as a solid even when it is in a liquid form.

In the present specification, when two or more types of component are present, the “content” of the component means the total content of the two or more types of component.

In the present specification, “ppm” means “parts-per-million (10⁻⁶),” and “ppb” means “parts-per-billion (10⁻⁹).” “ppt” means “parts-per-trillion (10⁻¹²).”

The chemical solution of the invention, the chemical solution-housing article of the invention, the preparation of the chemical solution, and an electronic device production method will be described successively.

### Chemical Solution

The chemical solution of the invention will next be described.

The chemical solution of the invention is a chemical solution containing 2-heptanone, water, and a carbonyl compound having 6 to 8 carbon atoms other than 2-heptanone (which is hereinafter referred to also as a “specific carbonyl compound”). The content of 2-heptanone is 60% by mass or more based on the total mass of the chemical solution, and the content of water is 1 to 1000 ppm by mass based on the total mass of the chemical solution. P determined from formula (1) described later (which is hereinafter referred to simply as the “P value”) is 3 to 10.

The phrase “the effects of the invention are enhanced” indicates that at least one of the in-plane cleanliness uniformity on a substrate, the wafer bevel cleanliness, or the capability of preventing the occurrence of defects on the substrate upon contact with the substrate is high.

### 2-Heptanone

The chemical solution of the invention contains 2-heptanone.

The content of 2-heptanone is 60% by mass or more based on the total mass of the chemical solution. When the content of 2-heptanone in the chemical solution is within the above range, the chemical solution obtained exhibits a high ability to dissolve a metal resist film.

The content of 2-heptanone is preferably 65% by mass or more, more preferably 70% by mass or more, and still more preferably 80% by mass or more because the ability to dissolve the metal resist film is higher. No particular limitation is imposed on the upper limit of the content of 2-heptanone, and the 2-heptanone may be the remainder excluding water, the carbonyl compound, and optional components described later. The content of 2-heptanone is, for example, 99.999% by mass or less and preferably 99.99% by mass or less based on the total mass of the chemical solution.

### Water

The chemical solution of the invention contains water. The content of water contained in the chemical solution of the invention is 1 to 1000 ppm by mass based on the total mass of the chemical solution.

In the chemical solution containing 2-heptanone, water, and the specific carbonyl compound, when the content of water is within the above range, the capability of preventing the occurrence of defects on the substrate when the chemical solution is brought into contact with the substrate (which may be hereinafter referred to also as “the capability of preventing the occurrence of defects caused by water”) is improved. The reason that the capability of preventing the occurrence of defects caused by water is improved when the content of water is within the above range is unclear but may be as follows. For example, when the content of water is more than or equal to the above lower limit, the electric conductivity of the chemical solution increases, and this may reduce electrification on the surface of a member (such as a pipe or a filter) in contact with the chemical solution in the step of preparing the chemical solution. In this case, the occurrence of sparks that cause the dielectric breakdown of the contact member is reduced, and it is inferred that mixing of foreign substances due to the dielectric breakdown and the occurrence of defects on the surface of the substrate due to the foreign substances can be suppressed. When the content of water is less than or equal to the upper limit described above, it is inferred that the occurrence of stain-like defects caused by water remaining on the surface of the substrate can be prevented.

From the foregoing points of view, the lower limit of the content of water is preferably 5 ppm by mass or more and more preferably 10 ppm by mass or more based on the total mass of the chemical solution.

From the foregoing points of view, the upper limit of the content of water is preferably 500 ppm by mass or less and more preferably 100 ppm by mass or less based on the total mass of the chemical solution.

The content of water can be measured using a device that uses a Karl Fischer moisture measurement method as the measurement principle. The device used may be, for example, a Karl Fischer moisture meter (product name: “MKC-710M” manufactured by Kyoto Electronics Manufacturing Co., Ltd., Karl Fischer coulometric titration type).

Examples of the water include distilled water, ion exchanged water, pure water, and ultrapure water, and ultrapure water is preferred.

The water may be intentionally added water, may be water inevitably contained in the raw materials of the chemical solution, or may be water inevitably mixed during the production, storage, and/or transportation of the chemical solution.

No particular limitation is imposed on the method for controlling the water content. A method in which water is removed from the chemical solution and/or the raw materials used to prepare the chemical solution, a method in which water is added, or a combination of these methods may be used.

The method for removing water may be any well-known dewatering method, and examples include dewatering using a water adsorbent, distillation, and dewatering using a dewatering membrane.

Examples of the water adsorbent include zeolite (such as a molecular sieve), sodium sulfate, magnesium sulfate, silica gel, calcium chloride, anhydrous zinc chloride, fuming sulfuric acid, and soda lime.

Examples of the dewatering method using a dewatering membrane include membrane dewatering by pervaporation (PV) or vapor permeation (VP). Examples of the dewatering membrane include membranes formed of polymer-based materials such as polyimide-based, cellulose-based, and polyvinyl alcohol-based materials and membranes formed of inorganic-based materials such as zeolite.

### Specific Carbonyl Compound

The chemical solution of the invention contains the specific carbonyl compound, which is a carbonyl compound having 6 to 8 carbon atoms other than 2-heptanone.

No particular limitation is imposed on the specific carbonyl compound, so long as it is a compound that is other than 2-heptanone, has a carbonyl group, and has 6 to 8 carbon atoms. Examples of the specific carbonyl compound include a ketone having 6 to 8 carbon atoms other than 2-heptanone (which may be hereinafter referred to also as a “specific ketone”) and an aldehyde having 6 to 8 carbon atoms (which may be hereinafter referred to also as a “specific aldehyde”).

No particular limitation is imposed on the number of carbonyl groups included in the specific carbonyl compound, and the number of carbonyl groups is preferably one or two and more preferably one.

The specific carbonyl compound is preferably a carbonyl compound represented by any of the chemical formulas C₆H₁₂O, C₇H₁₄O, and C₈H₁₆O and is more preferably a carbonyl compound represented by the chemical formula C₇H₁₄O.

Examples of the specific ketone used as the specific carbonyl compound include: ketones having 6 carbon atoms such as 2-hexanone, 3-hexanone, 4-methyl-2-pentanone, and 3-methyl-2-pentanone; ketones having 7 carbon atoms (except 2-heptanone) such as 3-heptanone, 4-heptanone, 5-methyl-2-hexanone, 5-methyl-3-hexanone, and 4-methyl-3-hexanone; and ketones having 8 carbon atoms such as 2-octanone, 3-octanone, 4-octanone, 5-methyl-2-heptanone, 5-methyl-3-heptanone, and 4-methyl-3-heptanone.

Of these, 5-methyl-2-hexanone, 4-heptanone, 3-heptanone, or 5-methyl-3-hexanone is preferred, and 5-methyl-2-hexanone or 4-heptanone is preferred, because the effects of the invention are further enhanced.

Examples of the specific aldehyde used as the specific carbonyl compound include: aldehydes having 6 carbon atoms such as 2-methylpentanal, 2-ethylbutanal, and 3-methylpentanal; aldehydes having 7 carbon atoms such as 2-methylhexanal, 2-ethyl-3-methylbutanal, 2-ethylpentanal, and 3-methylhexanal; and aldehydes having 8 carbon atoms such as 2-methylheptanal, 2-ethyl-3-methylpentanal, 2-ethylhexanal, and 6-methylheptanal.

Of these, 2-methylhexanal, 2-ethyl-3-methylpentanal, or 2-ethylhexanal is preferred, because the effects of the invention are further enhanced.

The specific carbonyl compound is preferably 5-methyl-2-hexanone, 4-heptanone, 3-heptanone, 5-methyl-3-hexanone, 2-methylhexanal, 2-ethyl-3-methylbutanal, or 2-ethylhexanal and more preferably 5-methyl-2-hexanone or 4-heptanone, because the effects of the invention are further enhanced.

One specific carbonyl compound may be used alone, or a combination of two or more specific carbonyl compounds may be used.

When the chemical solution contains two or more specific carbonyl compounds, the chemical solution may contain two or more specific ketones, may contain two or more specific aldehydes, or may contain a combination of one or more specific ketones and one or more specific aldehydes.

### Ratio of Content of Specific Aldehyde to Content of Specific Ketone

No particular limitation is imposed on the ratio of the content of specific aldehyde to the content of the specific ketone when the chemical solution contains a combination of the specific ketone and the specific aldehyde. However, the ratio of the content of the specific aldehyde to the content of the specific ketone in the chemical solution is preferably 1.0×10⁻⁶ to 1.0×10³, more preferably 1.0×10⁻⁵ to 1.0×10², still more preferably 1.0×10⁻⁴ to 5.0×10¹, and particularly preferably 1.0×10⁻³ to 1.0×10¹, because the effects of the invention and the capability of preventing the adhesion of organic substances to the washed substrate are further enhanced.

The polarity and reactivity of the specific ketone differ from those of the specific aldehyde. It is inferred that, since these materials with different properties are mixed within the specified ratio range, the capability of removing the metal resist on the surface of a target object and the rinsing capability are improved.

The content of the specific carbonyl compound is preferably 0.1 ppm by mass or more, more preferably 0.5 ppm by mass or more, and still more preferably 1.0 ppm by mass or more based on the total mass of the chemical solution.

The content of the specific carbonyl compound is preferably 1000 ppm by mass or less, more preferably 500 ppm by mass or less, and still more preferably 100 ppm by mass or less, based on the total mass of the chemical solution.

The contents of organic compounds such as the specific carbonyl compound and a specific cycloalkane compound described later that are contained in the chemical solution can be measured by GC-MS (gas chromatography mass spectrometry). A well-known GC-MS device may be used for the GC-MS, and examples of the device include a device including a combination of a gas chromatograph “7890B” (manufactured by Agilent) and a mass spectrometer “JMS-Q1500” (manufactured by JEOL Ltd.).

No particular limitation is imposed on the method for controlling the content of the specific carbonyl compound. One example of the method is a method including preparing a solution to be purified that contains 2-heptanone as a main component and a very small amount of organic impurities such as the specific carbonyl compound using a method described later, optionally subjecting the prepared solution to purification treatment, and optionally adding the specific carbonyl compound.

### P Value

One feature of the chemical solution of the invention is that the chemical solution contains water and the specific carbonyl compound in such amounts that the P value determined from the following formula (1) is 3 to 10.

$$P = - {log}_{10} ( X \times Y ) \qquad formula ( 1 )$$

Here, X is the numerical value X when the concentration of water in the chemical solution is denoted by X mol/L, and Y is the numerical value Y when the concentration of the carbonyl compound in the chemical solution is denoted by Y mol/L.

In the chemical solution containing 2-heptanone, water, and the specific carbonyl compound, when the P value is within the above range, the in-plane cleanliness uniformity on the substrate after contact with the chemical solution (which may be hereinafter referred to simply as “in-plane cleanliness uniformity”) and the capability of washing the beveled portion of the substrate upon contact with the chemical solution (which may be hereinafter referred to also as “wafer bevel cleanliness”) are improved. The reason that the capability of preventing the occurrence of defects caused by water is improved when the P value is within the above range is unclear, but the reason may be as follows.

The specific carbonyl compound is believed to adsorb on the surface of a substrate formed of silicon or a silicon derivative (such as TEOS, a Low-k material, or SiN) to induce defects or affect the action of the chemical solution on target materials. In particular, in a chemical solution used for the process of producing leading-edge semiconductor devices, even if the chemical solution contains trace amounts of organic impurities other than the main solvent, these organic impurities may affect the yield of the devices. However, when the chemical solution contains the specific carbonyl compound and water in such amounts that the P value is less than or equal to the upper limit described above, the carbonyl group of the specific carbonyl compound is hydrated to form a hydrate that has a smaller dipole moment than the specific carbonyl compound and that is less likely to adhere to the surface of the substrate. In this case, since the area of the substrate surface that is affected by the specific carbonyl compound other than 2-heptanone is small, it can be inferred that the in-plane cleanliness uniformity on the surface of the substrate is improved. Moreover, when the chemical solution contains the specific carbonyl compound and water in such amounts that the P value is more than or equal to the lower limit described above, the amount of the hydrate whose wettability significantly differs from that of 2-heptanone serving as the main component is reduced to a prescribed level or less. In this case, it is inferred that the fluidity of the chemical solution on the beveled portion with an edge bead is maintained and the washing capability on the beveled portion is improved.

The P value of the chemical solution is preferably 3.5 or more, more preferably 4 or more, and still more preferably 5 or more, because the effects of the invention are further enhanced. The P value of the chemical solution is preferably 9 or less, more preferably 8.5 or less, and still more preferably 8 or less, because the effects of the invention are further enhanced.

### Optional Components

The chemical solution may contain optional components other than the components described above.

Examples of the optional components include a specific cycloalkane compound described below, metal atoms such as Mn atoms and Fe atoms, and a surfactant.

### Specific Cycloalkane Compound

The chemical solution may further contain a cycloalkane compound having a boiling point or 160° C. or higher and having 8 to 12 carbon atoms (which may be hereinafter referred to also as a “specific cycloalkane compound”), and it is preferable that the chemical solution contains the specific cycloalkane compound.

No particular limitation is imposed on the specific cycloalkane compound, so long as it has a boiling point of 160° C. or higher, having a cycloalkane ring, and having 8 to 12 carbon atoms.

The cycloalkane ring included in the specific cycloalkane compound may be monocyclic or may be polycyclic but is preferably monocyclic.

The cycloalkane ring is, for example, a cycloalkane ring having 5 to 10 carbon atoms and is preferably a cyclopentane ring, a cyclohexane ring, or a cycloheptane ring and more preferably a cyclohexane ring.

The cycloalkane ring may have a substituent. Preferably, the specific cycloalkane compound is a compound including the cycloalkane ring having a substituent.

The substituent is, for example, preferably a hydrocarbon group and more preferably an alkyl group. Specifically, the specific cycloalkane compound is preferably a hydrocarbon. The number of carbon atoms in the hydrocarbon or alkyl group is appropriately selected such that the total number of carbon atoms in the cycloalkane ring and the hydrocarbon or alkyl group is in the range of 8 to 12, and the number of carbon atoms in the hydrocarbon or alkyl group is, for example, 1 to 3.

The cycloalkane ring may have only one substituent or may have two or more substituents.

The specific cycloalkane compound is preferably a compound having a boiling point of 150 to 190° C. and more preferably a compound having a boiling point of 160 to 180° C.

Specific examples of the specific cycloalkane compound include 1-methyl-2-isopropylcyclohexane (boiling point: 170.85° C.), 1-methyl-3-isopropylcyclohexane (boiling point: 161° C.), 1-methyl-4-isopropylcyclohexane (boiling point: 171° C.), 1-methyl-2-propylcyclohexane (boiling point: 176.15° C.), 1-methyl-3-propylcyclohexane (boiling point: 172.55° C.), and 1-methyl-4-propylcyclohexane (boiling point: 170.08° C.).

Of these, 1-methyl-2-isopropylcyclohexane, 1-methyl-3-isopropylcyclohexane, or 1-methyl-4-isopropylcyclohexane is preferred, and 1-methyl-4-isopropylcyclohexane is more preferred.

One specific cycloalkane compound may be used alone, or a combination of two or more specific cycloalkane compounds may be used.

The content of the specific cycloalkane compound may be, for example, 0.1 to 1000 ppm by mass based on the total mass of the chemical solution. The content of the specific cycloalkane compound is preferably 0.3 ppm by mass or more, more preferably 0.5 ppm by mass or more, and still more preferably 1.0 ppm by mass or more based on the total mass of the chemical solution. When the chemical solution contains the specific cycloalkane compound in an amount within the above range, the capability of dissolving and removing low-polarity organic substances adhering to the substrate surface when the surface is treated with the chemical solution can be improved.

The content of the specific cycloalkane compound is preferably 1000 ppm by mass or less, more preferably 700 ppm by mass or less, still more preferably 500 ppm by mass or less, and particularly preferably 100 ppm by mass or less based on the total mass of the chemical solution, because the chemical solution is prevented from remaining on the substrate as an organic substance after the chemical solution is brought into contact with the substrate and dried and/or baked.

### Metal Atoms

The chemical solution may contain Mn atoms (manganese atoms).

Preferably, the chemical solution contains Mn atoms because the occurrence of defects derived from the chemical solution when the chemical solution is brought into contact with the substrate is reduced.

No particular limitation is imposed on the form of the Mn atoms in the chemical solution. The Mn atoms may be contained as Mn particles or as Mn ions.

The Mn particles may be in the form of single metal particles composed of Mn atoms, in the form of particles of an alloy of Mn atoms and other metal atoms, or in the form of particles composed of Mn atoms associated with an organic substance. The Mn ions may form a salt or a complex.

The content of the Mn atoms in the chemical solution is preferably 20 ppt by mass or less, more preferably 10 ppt by mass or less, still more preferably 7.5 ppt by mass or less, particularly preferably 5 ppt by mass or less, and most preferably 1.0 ppt by mass or less based on the total mass of the chemical solution. When the content of the Mn atoms is within the above range, the occurrence of nanoparticle defects derived from the Mn atoms can be reduced.

The lower limit of the content of the Mn atoms is preferably 0.001 ppt by mass or more, more preferably 0.005 ppt by mass or more, and still more preferably 0.01 ppt by mass or more based on the total mass of the chemical solution.

The chemical solution may contain Fe (iron) atoms in addition to the Mn atoms.

No particular limitation is imposed on the form of the Fe atoms in the chemical solution. The Fe atoms may be contained as Fe particles or as Fe ions.

The Fe particles may be in the form of single metal particles composed of Fe atoms, in the form of particles of an alloy of Fe atoms and metal atoms other than Mn atoms, or in the form of particles composed of Fe atoms associated with an organic substance. The Fe ions may form a salt or a complex.

When the chemical solution contains Mn atoms and Fe atoms, the ratio of the content of the Mn atoms to the content of the Fe atoms (which may be hereinafter referred to also as the “Mn/Fe ratio”) in the chemical solution is preferably 1.0×10⁻³ to 1.0, more preferably 1.0×10⁻² to 7.0×10⁻¹, still more preferably 1.0×10⁻² to 5.0×10⁻¹, and particularly preferably 5.0×10⁻² to 2.5×10⁻¹ because the effects of the invention and the capability of preventing the occurrence of defects derived from the chemical solution are further enhanced.

The reason that the capability of preventing the occurrence of defects derived from the chemical solution is high when the Mn/Fe ratio is within the above range is unclear, but the reason may be as follows. When the Mn/Fe ratio is less than or equal to the upper limit described above, the relative content of Mn that has a lower oxidation-reduction potential than Fe and is more likely to be present as ions is low. In this case, since the ratio of Fe present as particles to the total amount of Fe atoms is reduced, it can be inferred that the occurrence of defects derived from the chemical solution and caused by Fe present as particles can be reduced. When the Mn/Fe ratio is more than or equal to the lower limit described above, it is inferred that the occurrence of nanoparticles caused by the Fe atoms can be reduced.

The content of the Fe atoms in the chemical solution is preferably 0.01 to 200 ppt by mass, more preferably 0.05 to 100 ppt by mass, still more preferably 0.1 to 50 ppt by mass, and particularly preferably 0.1 to 1 ppt by mass based on the total mass of the chemical solution.

The Mn atoms and the Fe atoms (which may be hereinafter referred to collectively as “specific metal atoms”) may be those intentionally added, may be those inevitably contained in the raw materials of the chemical solution, or may be those inevitably mixed during the production, storage, and/or transportation of the chemical solution.

No particular limitation is imposed on the method for controlling the content of the specific metal atoms. A method in which the specific metal atoms are removed from the chemical solution and/or the raw materials used to prepare the chemical solution, a method in which a component containing the specific metal atoms (a specific metal atom source) is added, or a combination of these methods may be used.

Examples of the removal of the specific metal atoms from the chemical solution and/or the raw materials used to prepare the chemical solution include removal of metal particles, metal ions, etc. from the raw materials.

In particular, a method in which a specific metal atom source is added to a mixture of the raw materials from which the specific metal atoms have been removed is preferred because the chemical composition can be easily controlled.

To remove the specific metal atoms, any well-known method may be appropriately selected according to the form of the specific metal atoms in the chemical solution and/or the raw materials used to prepare the chemical solution. Examples of the method include purification treatment such as ion removal treatment and filtration treatment described later. When the specific metal atoms are in the form of metal particles, the filtration treatment is preferred. When the specific metal atoms are in the form of metal ions, the ion removal treatment is preferred.

No particular limitation is imposed on the specific metal atom source. Examples of the specific metal atom source include metal particles such as metal nanoparticles, metal oxide particles, and metal ion-containing compounds such as metal salts (e.g., metal halides) and organic metal complexes, and metal nanoparticles are preferred.

In the chemical solution, the contents of additional metal atoms (such as Pb, Cr, Ni, Sn, Co, Na, Cu, Mg, Li, Al, and Ag) other than the Mn and Fe atoms are each preferably 1000 ppt by mass or less and more preferably 500 ppt by mass or less. In the production of leading-edge semiconductor elements, higher purity chemical solutions are expected to be required. Therefore, the contents of the additional metal atoms are each more preferably less than 500 ppt by mass, particularly preferably less than 150 ppt by mass, and most preferably less than 100 ppt by mass. The lower limit is preferably 0.

Examples of the method for reducing the contents of the additional metal atoms include purification treatment such as filtration treatment, ion removal treatment, and distillation treatment described later.

Other examples include a method in which a container from which the dissolution of metal components is small is used as a container for storing the raw materials or the produced chemical solution and a method in which the inner walls of pipes used during the production of the chemical solution are lined with a fluorocarbon resin in order to prevent the dissolution of the metal components from the pipes.

The contents of the Mn atoms and the Fe atoms, the types of additional metal atoms, and their contents can be measured by ICP-MS (inductively coupled plasma mass spectrometry).

Examples of the device that can be used for ICP-MS include an Agilent 8900 triple quadrupole ICP-MS (inductively coupled plasma mass spectrometry for semiconductor analysis, option: #200) manufactured by Agilent Technologies Inc., NexION 350S manufactured by PerkinElmer, and Agilent 8800 manufactured by Agilent Technologies Inc.

When the contents of the metal atoms in the chemical solution are measured, the measurement may be performed after the chemical solution is concentrated. The chemical solution is concentrated as follows.

A container used for concentration is a polytetrafluoroethylene-made container. Next, the chemical solution is heated to 160 to 180° C. at reflux to remove at least part of an organic solvent and water contained in the chemical solution, and the chemical solution is thereby concentrated.

In the concentration process, the contents of the metal atoms in chemical solutions with different concentration factors from 10 to 1000 are computed. When positive correlation (positive first-order correlation) is found between the concentration factor and the contents of the metal atoms, the contents of the metal atoms contained in the chemical solutions can be quantified by the method described above.

### Surfactant

The surfactant used may be any well-known surfactant, and examples include nonionic surfactants and fluorine-based surfactants.

Compounds exemplified in paragraph of WO2022/044893A can be used as the surfactant.

### Coarse Particles

The chemical solution may contain coarse particles, but it is preferable that the content of the coarse particles is small.

The coarse particles mean particles having a diameter (particle size) of 1 μm or more when the shape of each particle is assumed to be spherical.

The coarse particles contained in the chemical solution are particles such as dust, dirt, organic solids, and inorganic solids that are contained in the raw materials as impurities and particles such as dust, dirt, organic solids, and inorganic solids that are brought into the chemical solution as contaminants during its preparation. The coarse particles do not dissolve in the final chemical solution and are present as particles.

As for the content of the coarse particles in the chemical solution, the number of particles with a diameter of 1 μm or more is preferably 100 or less per 1 mL of the chemical solution and more preferably 50 or less per 1 mL of the chemical solution. The lower limit of the content is preferably 0.

The content of the coarse particles in the chemical solution can be measured in its liquid phase using a commercial measurement device that uses a laser as a light source and a light scattering type in-liquid particle measurement method.

Examples of the method for removing the coarse particles include purification treatment such as filtration treatment described later.

### Applications

The chemical solution of the invention can be used for a semiconductor substrate production process and is particularly preferably used as a treatment solution used for a semiconductor substrate.

Examples of the treatment solution include a washing liquid (etchant) for removing target materials on a semiconductor substrate, a developer for removing a resist film formed on a semiconductor substrate, a rinsing liquid for rinsing out materials adhering to a semiconductor substrate, and a pre-wetting liquid that is to be applied to a semiconductor substrate to improve the ease of application of the resist composition.

In particular, the chemical solution is used preferably as a washing liquid (more preferably a metal resist washing liquid such as an edge bead remover), a developer, a rinsing liquid, or a pre-wetting liquid in a semiconductor substrate production process including the step of forming a metal resist film using a metal resist composition.

The chemical solution of the invention can also be used for other applications such as a filter washing liquid, a pipe washing liquid, and a tank washing liquid.

To avoid the dissolution of a pattern formed using a metal resist composition, it is preferable that the ability of the chemical solution used as a rinsing liquid to dissolve the metal resist film is lower than that of a developer. The “ability of the developer or rinsing liquid to dissolve the metal resist” is an indicator indicating the ease of dissolution of the metal resist film in the developer or rinsing liquid. For example, when equal amounts of two different chemical solutions are supplied to a metal resist film, one of the two chemical solutions that dissolves a smaller amount of the metal resist film (causes a smaller reduction in the volume of the metal resist film) per unit time is the chemical solution whose ability to dissolve the metal resist film is lower.

Generally, the dissolving ability of a developer is such that the metal resist film in exposed portions does not dissolve. However, when a rinsing liquid whose dissolving ability is higher than that of the developer is used, it is feared that the metal resist film in the exposed portions may dissolve and the pattern shape may collapse. Moreover, in some regions of the exposed portions in which the metal resist film is present, the polymerization reaction may proceed less readily than in the other regions of the exposed portions of the resist film, and these regions may more readily dissolve in an organic solvent. In this case, when the ability of the rinsing liquid to dissolve the metal resist film is the same as that of the developer, it is feared that these regions may dissolve slightly and the shape of the pattern may collapse. However, the collapse of the pattern may be prevented by using, as the rinsing liquid, a chemical solution whose ability to dissolve the metal resist film is lower than that of the developer.

When the chemical solution of the invention is used as a developer and then a rinsing liquid is used for washing, no particular limitation is imposed on the rinsing liquid so long as it is a chemical solution or rinsing liquid whose ability to dissolve the metal resist film is lower than that of the developer.

The rinsing liquid may be a mixture of two or more organic solvents.

When the developer is the chemical solution of the invention, the rinsing liquid is, for example, methyl isobutyl carbinol (MIBC), PGMEA (propylene glycol monomethyl ether acetate), PGME (propylene glycol monomethyl ether), a mixture of PGMEA and PGME, or nBA (n-butyl acetate).

The rinsing liquid may be purified using a purification method described later for various components contained in the chemical solution.

### Method for Preparing Chemical Solution

The chemical solution can be prepared using any well-known method. For example, the chemical solution can be prepared by mixing the components described above such that prescribed concentrations are obtained. No particular limitation is imposed on the order in which these components are mixed.

To remove excess portions of the components and/or impurities, the raw materials of the chemical solution and/or a mixture of the raw materials may be subjected to purification treatment.

In particular, it is preferable that 2-heptanone, water, the specific carbonyl compound, and the specific cycloalkane compound used to prepare the chemical solution are products obtained by subjecting materials to be purified containing these components to purification treatment.

When a chemical solution containing the specific metal atoms described above in prescribed amounts is prepared, it is preferable to prepare the chemical solution containing the prescribed components as follows. Unpurified products containing the above-described components (2-heptanone, water, the specific carbonyl compound, and the specific cycloalkane compound) are subjected to purification treatment to reduce the amounts of impurities such as the specific metal atoms, and the resulting raw materials are mixed to obtain a solution mixture. Then prescribed amounts of the specific metal atoms are supplied to the solution mixture to prepare the chemical solution containing the prescribed components. In this case, by subjecting the unpurified products containing the components used (2-heptanone, water, the specific carbonyl compound, and the specific cycloalkane compound) to purification treatment as described above, the amount of impurities other than the specific metal atoms can also be reduced.

The unpurified products may be, for example, purchased or may be synthesized from raw materials.

It is preferable that the content of impurities in the unpurified products is low. Examples of commercial products that meet this requirement include commercial products called “semiconductor-grade products” and “high purity grade products.”

When the unpurified product containing 2-heptanone contains very small amounts of the above-described components other than 2-heptanone, the contents of the components other than 2-heptanone can be very easily controlled within the ranges described above by adding these components other than 2-heptanone to the unpurified product containing 2-heptanone. Therefore, it is preferable to prepare 2-heptanone by a method using a hydration reaction of an alkyne.

Specifically, 1-heptyne and water are reacted in the presence of an acid catalyst and mercury ions to add water to a triple bond included in 1-heptyne, and 1-hepten-2-ol is thereby generated. The 1-hepten-2-ol generated is subjected to keto-enol tautomerism, and an unpurified product containing 2-heptanone can thereby be prepared. For details on the method for synthesizing 2-heptanone through a hydration reaction of an alkyne, reference can be made to a synthesis method described in page 283 of “Organic Chemistry 4th Edition” (William H. Brown, Christopher S. Foote, and Brent L. Iverson, Brooks/Cole Publishing Company, 2004).

To purify an unpurified product, any well-known method can be used. Examples of the purification method include filtration treatment, ion removal treatment, and distillation treatment.

To purify an unpurified product, a combination of a plurality of types of treatment selected from the group consisting of filtration treatment, ion removal treatment, and distillation treatment may be performed. For example, after primary purification in which an unpurified product is distilled, the resulting unpurified product may be subjected to secondary purification in which the unpurified product is caused to pass through an ion exchange resin and/or a filter. Alternatively, after primary purification in which an unpurified product is caused to pass through an ion exchange resin and/or a filter, the resulting unpurified product may be subjected to secondary purification in which the resulting unpurified product is distilled.

Each purification treatment may be repeated a plurality of times.

### Filtration Treatment

No particular limitation is imposed on the filtration treatment method, and any well-known method can be used. In particular, it is preferable to use filtration treatment in which an unpurified product is filtered using a filter. No particular limitation is imposed on the components removed by the filtration treatment, and examples of the components include metal particles and coarse particles.

No particular limitation is imposed on the filter used for the filtering, and any well-known filter can be used.

Examples of the material of the filter include fluorocarbon resins such as PTFE (polytetrafluoroethylene) and PFA (perfluoroalkoxyalkane), polyamide-based resins such as 6-nylon and 6,6-nylon, polyolefin resins (including high-density and ultrahigh-molecular weight polyolefin resins) such as polyethylene and polypropylene, diatomaceous earth, and glass. In particular, PTFE, polyamide-based resins, UPE (ultrahigh-density polyethylene), HDPE (high-density polyethylene), and HDPP (high-density polypropylene) are preferred. By using a filter formed of any of these materials, highly polar foreign substances and metallic impurities that are likely to cause particle defects can be removed more effectively.

The critical surface tension of the filter is preferably 70 to 95 mN/m and more preferably 75 to 85 mN/m. The value of the critical surface tension used may be the manufacturer's nominal value.

When the critical surface tension of the filter used is within the above range, highly polar foreign substances and metallic impurities that are likely to cause particle defects can be removed more effectively.

The pore diameter of the filter is preferably 0.1 nm to 1.0 μm, more preferably 0.5 nm to 0.1 μm, and still more preferably 1.0 to 50.0 nm. When the pore diameter of the filter is within the above range, fine foreign substances contained in the unpurified product can be removed effectively while clogging of the filter is prevented.

The filter may have been subjected to surface treatment. No particular limitation is imposed on the surface treatment method, and any well-known method can be used. Examples of the surface treatment include chemical modification treatment, plasma treatment, hydrophobic treatment, coating, gas treatment, and sintering. Of these, chemical modification treatment or plasma treatment is preferred.

The chemical modification treatment is preferably treatment in which ion exchange groups are introduced. Specifically, the filter may be an ion exchange filter.

Examples of the ion exchange group include: cation exchange groups such as a sulfonate group, a carboxy group, and a phosphate group; and anion exchange groups such as a quaternary ammonium group. No particular limitation is imposed on the method for introducing the ion exchange groups into the filter. In one exemplary method, a compound including an ion exchange group and a polymerizable group is reacted and grafted with a polymer contained in the filter.

The filtering may be multistage filtration treatment in which the unpurified product is caused to pass through two or more filters different in at least one selected from the group consisting of filter material, pore diameter, and pore structure. Alternatively, the unpurified product may be caused to pass through the same filter a plurality of times or may be caused to pass through a plurality of filters of the same type.

In particular, circulating filtration treatment is preferred in which a filtration device including a combination of a plurality of filters and a return passage is used to cause the unpurified product to pass through the filters a plurality of times.

No particular limitation is imposed on the number of times the circulating filtration is repeated. The number of repetitions may be appropriately selected according to the intended purity and impurities and is preferably 2 to 100, more preferably 20 to 80, and still more preferably 30 to 70.

No particular limitation is imposed on the number of filters used in combination, and the number of filters is preferably 1 to 10 and more preferably 2 to 5.

When the filtering is performed using a combination of different filters, it is preferable that the pore diameter of the filter that first comes into contact with the liquid is larger than or equal to the pore diameter of the filter that subsequently comes into contact with the liquid. The nominal value of each filter provided by the manufacturer can be used for the pore diameter of the filter.

Examples of the commercial filter include various filters available from Nihon Pall Ltd., Advantec Toyo Kaisha, Ltd., Nihon Entegris G. K., KITZ MICROFILTER CORPORATION, etc., and the filters used can be selected from these filters.

The temperature during filtering is preferably 25° C. or lower, more preferably 23° C. or lower, and still more preferably 20° C. or lower. The lower limit is preferably 0° C. or higher, more preferably 5° C. or higher, and still more preferably 10° C. or higher. When the temperature during filtering is within the above range, particulate foreign substances and impurities dissolved in the chemical solution precipitate and can be removed efficiently.

### Ion Removal Treatment

The ion removal treatment is treatment in which an unpurified product is subjected to ion exchange treatment or ion adsorption treatment using chelating groups. No particular limitation is imposed on the components removed by the ion removal treatment, but examples thereof include acids and metal ions.

No particular limitation is imposed on the ion exchange treatment method, and any well-known method can be used. Examples of the method include a method in which the unpurified product is brought into contact with an ion exchange resin. A method in which the unpurified product is caused to pass through a packed section packed with the ion exchange resin is preferred.

In the ion exchange treatment, the unpurified product may be caused to pass through the same ion exchange resin a plurality of times or may be caused to pass through different ion exchange resins.

Examples of the ion exchange resin include anion exchange resins and cation exchange resins.

When both a cation exchange resin and an anion exchange resin are used, the unpurified product may be caused to pass through a packed section packed with a resin mixture containing these resins or may be caused to pass through a plurality of packed sections packed with respective resins.

The anion exchange resin used may be any well-known anion exchange resin, and it is preferable to use a gel-type anion exchange resin.

Examples of the anion exchange resin include strongly basic anion exchange resins having quaternary ammonium groups and weakly basic anion exchange resins having amino groups.

The anion exchange resin used may be a commercial product, and examples thereof include: Amberlite IRA-400J, Amberlite IRA-410J, Amberlite IRA-900J, Amberlite IRA67, ORLITE DS-2, ORLITE DS-5, and ORLITE DS-6 (manufactured by Organo Corporation); DUOLITE A113LF, DUOLITE A116, and DUOLITE A-375LF (manufactured by Sumika Chemtex Co., Ltd.); and DIAION SA12A, DIAION SA10A, DIAION SA10AOH, DIAION SA20A, and DIAION WA10 (manufactured by Mitsubishi Chemical Corporation).

The anion exchange resin used may be an anion exchange resin described in JP2009-155208A.

The cation exchange resin used may be any well-known cation exchange resin and is preferably a gel-type cation exchange resin.

Specific examples of the cation exchange resin include sulfonic acid-type cation exchange resins and carboxylic acid-type cation exchange resins.

The cation exchange resin used may be a commercial product, and examples thereof include: Amberlite IR-124, Amberlite IR-120B, Amberlite IR-200CT, ORLITE DS-1, and ORLITE DS-4 (manufactured by Organo Corporation); DUOLITE C20J, DUOLITE C20LF, DUOLITE C255LFH, and DUOLITE C-433LF (manufactured by Sumika Chemtex Co., Ltd.); DIAION SK-110, DIAION SKIB, and DIAION SKIBH (manufactured by Mitsubishi Chemical Corporation); and Purolite S957 and Purolite S985 (manufactured by Purolite).

No particular limitation is imposed on the ion adsorption treatment using chelating groups, and any well-known method can be used. Examples of the ion adsorption treatment include a method in which the unpurified product is caused to pass through a packed section packed with a chelating resin having a chelating group.

In the ion removal treatment, the unpurified product may be caused to pass through the same chelating resin a plurality of times or may be caused to pass through different chelating resins.

Examples of the chelating resin include resins having a chelating ability or a chelating group such as an amidoxime group, a thiourea group, a thiouronium group, iminodiacetic acid, amidophosphoric acid, phosphonic acid, aminophosphoric acid, aminocarboxylic acid, N-methylglucamine, an alkylamino group, a pyridine ring, cyclic cyanine, a phthalocyanine ring, or a cyclic ether.

The ion removal treatment may be used in combination with the filtration treatment described above. For example, a method may be used in which a column packed with an ion exchange resin is installed in the circulating filtration device described above and the untreated product is caused to continuously pass through the ion exchange resin-packed section and the filter.

### Distillation Treatment

No particular limitation is imposed on the distillation treatment method, and any well-known method can be used. Examples of the method include a method using a distillation column. No particular limitation is imposed on the components removed by the distillation process, and examples include acids, organic compounds, and water.

No particular limitation is imposed on the liquid-contacting portion of the distillation column. It is preferable that the liquid-contacting portion is formed from a corrosion-resistant material. Examples of the corrosion-resistant material include materials used for a chemical solution-housing article described later.

In the distillation treatment, the unpurified product may be caused to pass through the same distillation column a plurality of times or may be caused to pass through different distillation columns.

When the unpurified product is caused to pass through different distillation columns, the following method, for example, may be used. The unpurified product is subjected to rough distillation treatment in which the unpurified product is caused to pass through a distillation column to remove low-boiling point acids etc. and then subjected to rectification treatment in which the resulting product is caused to pass through a distillation column different from the distillation column for the rough distillation treatment to remove acid components, other organic compounds, etc. Examples of the distillation column in the rough distillation treatment include a plate distillation column, and examples of the distillation column in the rectification treatment include a distillation column including at least one of a plate distillation column or a reduced pressure plate distillation column.

When the plate distillation column is used, the theoretical number of plates is preferably 50 or more and more preferably 100 or more. No particular limitation is imposed on the upper limit of the theoretical number of plates, but the number of plates is 200 or less in many cases.

For the purpose of achieving both thermal stability during distillation and precision of purification, reduced-pressure distillation may be used.

The distillation treatment used may be combined with at least one selected from the above-described filtration treatment and the above-described ion removal treatment. For example, the following method may be used. A distillation column is disposed on the primary side of a purification device used for the filtration treatment to introduce the distilled unpurified product into the purification device.

### Additional Purification Treatment

Purification treatment other than those described above such as dewatering treatment may be performed.

The dewatering treatment may be, for example, the water removal method described above.

It is preferable to prepare the chemical solution by the following method. An unpurified product containing 2-heptanone, an unpurified product containing water, and an unpurified product containing an organic acid are prepared. The unpurified products are subjected to purification treatment, and the resulting unpurified products are mixed to prepare the chemical solution.

Preferably, the purification treatment includes at least the distillation treatment and the filtration treatment. In this case, no particular limitation is imposed on the order of the distillation treatment and the filtration treatment. The filtration treatment may be performed after the distillation treatment, or the distillation treatment may be performed after the filtration treatment.

In the filtration treatment, it is preferable to use at least one first filter selected from the group consisting of ion exchange filters and filters containing polyamide-based resins (such as Nylon filters) and at least one second filter selected from the group consisting of PTFE filters and UPE filters. The first filter can remove mainly ionic impurities etc., and the second filter can remove mainly particles (such as metal particles and fine organic particles) etc.

A plurality of first filters and a plurality of second filters may be used. In particular, it is preferable to use three or more second filters.

As described above, the filtration treatment performed may be circulating filtration treatment. The number of repetitions of the circulating filtration is as described above but is preferably 30 or more.

In the distillation treatment, it is preferable that the unpurified product is caused to pass through different distillation columns.

The amount of impurities contained in the raw materials of the chemical solution can be reduced by the procedure described above, and the content of impurities in the chemical solution prepared can thereby be reduced.

### Handling

It is preferable that the handling and preparation of the chemical solution, the purification treatment, opening of a container of the chemical solution, washing of the container and devices, filling of the chemical solution, analysis, etc. are all performed in a clean room. Preferably, the cleanliness of the clean room is higher than or equal to class 4 defined in the international standard ISO 14644-1:2015 specified by the International Organization for Standardization. Specifically, the cleanliness of the clean room meets preferably ISO class 1, ISO class 2, ISO class 3, or ISO class 4, more preferably ISO class 1 or ISO class 2, or particularly preferably ISO class 1.

It is preferable that the handling, preparation, purification, housing, and storage of the chemical solution are performed at 30° C. or lower because the performance of the chemical solution can be maintained stably for a long time. The lower limit is preferably 5° C. or higher and more preferably 10° C. or higher.

### Chemical Solution-Housing Article

The chemical solution may be housed and stored in a container. A combination of the container and the chemical solution housed in the container is referred to as a chemical solution-housing article.

The chemical solution-housing article of the invention includes the container and the chemical solution of the invention housed in the container.

The container may be purged in advance with an inert gas (such as nitrogen or argon) with a purity of 99.99995% by volume or higher for the purpose of preventing deterioration of the components of the solution during storage. The inert gas is preferably a gas with a small moisture content. The chemical solution may be transported and/or stored at room temperature. However, the temperature may be controlled in the range of −20° C. to 20° C. in order to prevent deterioration.

### Container

The container used to house the chemical solution may be any well-known container and is preferably a high-cleanliness container for semiconductor applications from which elution of impurities is low.

Examples of the container include the “Clean Bottle” series (manufactured by AICELLO CHEMICAL CO., LTD.) and “Pure bottles” (manufactured by KODAMA PLASTICS Co., Ltd.). From the viewpoint of preventing mixing of impurities (contaminants) into the raw materials and the chemical solution, it is also preferable to use a multilayer container in which its inner wall has a six-layer structure formed of six resins or a multilayer container having a seven-layer structure formed of seven resins.

Examples of the multilayer container include containers described in JP2015-123351A, the entire contents of which are incorporated herein by reference.

Liquid-contacting portions (such as the container inner wall, the inlet for the chemical solution, and the outlet for the chemical solution) of the container that are to be in contact with the chemical solution may be formed of either a nonmetallic material or a metal material and are formed of preferably a nonmetallic material or stainless steel, from the viewpoint described below.

Preferably, the liquid-contacting portions of the container are formed of a nonmetallic material in order to prevent contamination.

No particular limitation is imposed on the nonmetallic material, and any well-known material can be used. Examples of the nonmetallic material include polyethylene resins, polypropylene resins, polyethylene-polypropylene resins, tetrafluoroethylene resins, tetrafluoroethylene-perfluoroalkyl vinyl ether copolymers, tetrafluoroethylene-hexafluoropropylene copolymer resins, tetrafluoroethylene-ethylene copolymer resins, chlorotrifluoroethylene-ethylene copolymer resins, vinylidene fluoride resins, chlorotrifluoroethylene copolymer resins, and vinyl fluoride resins. Of these, fluorine-based resins are preferably used in order to prevent contamination.

Specific examples of the container whose liquid-contacting portions are formed of a fluorine-based resin include FluoroPure PFA composite drums manufactured by Entegris. Containers described in page 4 etc. of JP1991-502677A (JPH03-502677A), page 3 etc. of WO2004/016526A, and pages 9 and 16 etc. of WO99/046309A can also be used.

When the container used has liquid-contacting portions formed of a nonmetallic material, it is preferable that the elution of an organic component in the nonmetallic material into the chemical solution is suppressed.

The liquid-contacting portions may be formed of a metal material.

No particular limitation is imposed on the metal material. A metal material containing chromium in an amount of more than 25% by mass based on the total mass of the metal material is preferred. Examples of the metal material include stainless steel and nickel-chromium alloys, and stainless steel is preferred.

No particular limitation is imposed on the stainless steel, and any well-known stainless steel can be used. In particular, an alloy containing nickel in an amount of 8% by mass or more is preferred, and austenitic stainless steel containing nickel in an amount of 8% by mass or more is more preferred. Examples of the austenitic stainless steel include SUS (Steel Use Stainless) 304 (Ni content: 8% by mass, Cr content: 18% by mass), SUS 304L (Ni content: 9% by mass, Cr content: 18% by mass), SUS 316 (Ni content: 10% by mass, Cr content: 16% by mass), and SUS 316L (Ni content: 12% by mass, Cr content: 16% by mass).

No particular limitation is imposed on the nickel-chromium alloy, and any well-known nickel-chromium alloy can be used. Examples of the nickel-chromium alloy include Hastelloy (trade name, the same applies to the following), Monel (trade name, the same applies to the following), and Inconel (trade name, the same applies to the following). More specific examples include Hastelloy C-276 (Ni content: 63% by mass, Cr content: 16% by mass), Hastelloy-C (Ni content: 60% by mass, Cr content: 17% by mass), and Hastelloy C-22 (Ni content: 61% by mass, Cr content: 22% by mass).

The nickel-chromium alloy may optionally further contain, in addition to the alloying elements described above, silicon, tungsten, molybdenum, copper, cobalt, etc.

The above metal material may preferably have been electropolished and is more preferably electropolished stainless steel.

Any well-known electropolishing method can be used, and examples thereof include methods described in [0011] to [0014] of JP2015-227501A and in [0036] to [0042] of JP2008-264929A.

The metal material may have been buffed for the purpose of preventing contamination. No particular limitation is imposed on the buffing method, and any well-known method can be used. No particular limitation is imposed on the size of abrasive grains used for finish buffing. The abrasive grain size is preferably less than or equal to #400 because irregularities on the surface of the metal material can be more easily reduced. Preferably, the buffing is performed before electropolishing.

The metal material may have been subjected to one of or a combination of two or more of the following processes: buffing including a plurality of stages performed using different abrasive grains with different sizes, washing with acid, and magnetic fluid grinding.

Preferably, the inside of the container has been washed before the container is filled with the chemical solution. The liquid used for the washing is preferably the chemical solution described above or a solution obtained by diluting the chemical solution.

### Pattern Forming Method

The chemical solution of the invention can be used for the following pattern forming method.

The pattern forming method includes: step 1 of forming a metal resist film on a substrate using an actinic ray-sensitive or radiation-sensitive composition (which is hereinafter referred to also as a “metal resist composition”) containing a metal compound having at least one bond selected from the group consisting of a metal-carbon bond and a metal-oxygen bond (this metal compound is hereinafter referred to also as a “specific metal compound”); step 2 of exposing the metal resist film to light; and step 3 of subjecting the light-exposed metal resist film to developing treatment using a developer to remove unexposed portions to thereby obtain a pattern. The pattern forming method may further include, after step 3, step 4 of washing the pattern using a rinsing liquid.

Each of the steps will be described in detail.

### Step 1

Step 1 is the step of forming the metal resist film using the metal resist composition.

Examples of the method for forming the metal resist film using the metal resist composition include a method in which the metal resist composition is applied to a substrate and a method in which the metal resist composition is vapor-deposited on a substrate. The metal resist composition will be described later.

Examples of the method in which the metal resist composition is applied to a substrate include a method in which the metal resist composition is applied to a substrate (such as a silicon substrate) used to produce semiconductor devices such as integrated circuits using a device such as a spinner or a coater.

The coating method is preferably spin coating using a spinner. The rotation speed during spin coating is preferably 1000 to 3000 rpm.

The metal resist film may be formed by drying the substrate coated with the metal resist composition.

Examples of the drying method include heating (pre-baking). Means included with a well-known exposing device and/or a well-known developing device can be used for the heating, and a hot plate may be used.

The heating temperature is preferably 80 to 150° C., more preferably 80 to 140° C., and still more preferably 80 to 130° C. The heating time is preferably 30 to 1000 seconds, more preferably 30 to 800 seconds, and still more preferably 40 to 600 seconds. The heating may be repeated two or more times.

The thickness of the metal resist film is preferably 10 to 90 nm, more preferably 10 to 65 nm, and still more preferably 15 to 50 nm because a more precise and finer pattern can be formed.

An undercoat film (such as an inorganic film, an organic film, or an antireflection film) may be formed between the substrate and the metal resist film. The undercoat film can be formed using a well-known organic or inorganic material. Examples of a composition for forming the undercoat film include AL412 (manufactured by Brewer Science) and the SHB series (such as SHB-A940 manufactured by Shin-Etsu Chemical Co., Ltd.).

The thickness of the undercoat film is preferably 10 to 90 nm, more preferably 10 to 50 nm, and still more preferably 10 to 30 nm.

A topcoat may be formed on a surface of the metal resist film that is opposite from the substrate using a topcoat composition.

Preferably, the topcoat composition does not mix with the metal resist film and can be applied uniformly to the surface of the metal resist film that is opposite from the substrate.

Preferably, the topcoat composition contains a resin, an additive, and a solvent.

The method for forming the topcoat may be, for example, any well-known topcoat forming method, and specific examples include a topcoat forming method described in [0072] to [0082] of JP2014-059543A.

### Metal Resist Composition

The metal resist composition contains the specific metal compound.

The specific metal compound is a metal compound having at least one bond selected from the group consisting of a metal-carbon bond (M-C) and a metal-oxygen bond (M-O). M represents a metal.

The metal-carbon bond is a state in which a metal atom and at least one carbon atom are bonded through a covalent bond, a coordinate bond, an ionic bond, a van der Waals bond, etc. The covalent bond may be a single bond, a double bond, or a triple bond. The metal-oxygen bond is a state in which at least one metal atom and at least one oxygen atom in the specific metal compound are bonded through a covalent bond, a coordinate bond, an ionic bond, a van der Waals bond, etc. The covalent bond may be a single bond or a double bond.

When the specific metal compound has a metal-carbon bond, the specific metal compound is a so-called organometallic compound.

The number of bonds in the specific metal compound that are selected from the above group is preferably 2 or more and more preferably 3 or more. The upper limit of the number of bonds is preferably 10 or less and more preferably 5 or less.

Examples of the metal atom included in the specific metal compound include group 3 to group 15 metal atoms in the periodic table, and the metal atom is preferably tin, antimony, tellurium, indium, hafnium, tantalum, tungsten, bismuth, titanium, cobalt, nickel, zirconium, or palladium and is more preferably tin.

In the present specification, silicon atoms are classified as metal atoms.

Examples of the specific metal compound include a compound represented by formula (1).

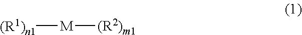

In formula (1), M represents a metal atom.

M is a metal atom included in the specific metal compound. The metal atom is preferably tin, antimony, tellurium, indium, hafnium, tantalum, tungsten, bismuth, titanium, cobalt, nickel, zirconium, or palladium and is more preferably tin.

In formula (1), R¹ represents an alkyl group optionally having a substituent, an unsaturated aliphatic hydrocarbon group optionally having a substituent, or an aryl group optionally having a substituent.

The alkyl group may be linear, branched, or cyclic.

The number of carbon atoms in the alkyl group is preferably 1 to 30, more preferably 1 to 16, and still more preferably 1 to 5. When the alkyl group represented by R¹ is an alkyl group having a substituent, the number of carbon atoms includes the number of carbon atoms in the substituent.

Examples of the optional substituent on the alkyl group include a halogen atom, a hydroxy group, a cyano group, a nitro group, an amino group, and aromatic ring groups. The aromatic ring group is preferably a phenyl group. The alkyl group having a phenyl group is preferably a benzyl group.

The unsaturated aliphatic hydrocarbon group is an aliphatic hydrocarbon group having an unsaturated group. Examples of the unsaturated group include a double bond and a triple bond.

The unsaturated aliphatic hydrocarbon group may be linear, branched, or cyclic.

The number of carbon atoms in the unsaturated aliphatic hydrocarbon group is preferably 2 to 30, more preferably 2 to 16, and still more preferably 2 to 5. When the unsaturated aliphatic hydrocarbon group represented by R¹ is an unsaturated aliphatic hydrocarbon group having a substituent, the number of carbon atoms includes the number of carbon atoms in the substituent.

The unsaturated aliphatic hydrocarbon group is preferably a vinyl group or an allyl group.

Examples of the optional substituent on the unsaturated aliphatic hydrocarbon group include halogen atoms, a hydroxy group, a cyano group, a nitro group, an amino group, and aromatic ring groups.

The aryl group may be monocyclic or may be polycyclic.

The number of carbon atoms in the aryl group is preferably 6 to 30, more preferably 6 to 12, and still more preferably 6 to 8. When the aryl group represented by R¹ is an aryl group having a substituent, the number of carbon atoms includes the number of carbon atoms in the substituent.

The aryl group is preferably a phenyl group or a naphthyl group.

Examples of the optional substituent on the aryl group include alkyl groups, halogen atoms, a hydroxy group, a cyano group, a nitro group, an amino group, and aromatic ring groups.

In formula (1), R² represents —OCOR^{r1} or —OR^{r2}. R^{r1} represents a hydrogen atom, an alkyl group optionally having a substituent, an unsaturated aliphatic hydrocarbon group optionally having a substituent, or an aryl group optionally having a substituent. R^{r2} represents an alkyl group optionally having a substituent, an unsaturated aliphatic hydrocarbon group optionally having a substituent, or an aryl group optionally having a substituent.

R² is preferably —OCOR^{r1}.

Examples of the alkyl group optionally having a substituent, the unsaturated aliphatic hydrocarbon group optionally having a substituent, and the aryl group optionally having a substituent that are represented by R^{r1} or R^{r2} include those of the groups represented by R¹ described above.

In formula (1), n1+m1 represents the valence of the metal atom represented by M.
n1+m1 is appropriately selected according to the possible valence of the metal atom represented by M.
n1 is preferably an integer of 0 to 2 and more preferably 1.
m1 is preferably an integer of 0 to 4 and more preferably 3.

When a plurality of R¹s are present, the R¹s may be the same or different. When a plurality of R²s are present, the R²s may be the same or different.

Other examples of the specific metal compound include a compound represented by formula (2) and condensates thereof.

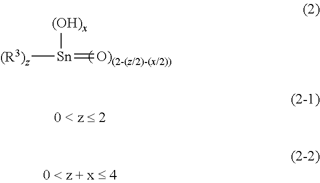

In formula (2), R³ represents a hydrocarbon group optionally having a substituent.

Examples of the hydrocarbon group include alkyl groups optionally having a substituent, unsaturated aliphatic hydrocarbon groups optionally having a substituent, and aryl groups optionally having a substituent. Preferred forms of the alkyl groups, the unsaturated aliphatic hydrocarbon groups, and the aryl groups are the same as the preferred forms of the groups represented by R¹.

When a plurality of R³s are present, the R³s may be the same or different.

z and x are numbers that satisfy the relation of formula (2-1) and the relation of formula (2-2).

Other examples of the specific metal compound include a compound represented by formula (3).

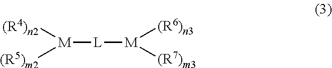

In formula (3), M represents a metal atom.

Examples of M include those of the metal atom represented by M in formula (1).

R⁴ and R⁶ each independently represent an alkyl group optionally having a substituent, an unsaturated aliphatic hydrocarbon group optionally having a substituent, or an aryl group optionally having a substituent.

Examples of R⁴ and R⁶ include those of the group represented by R¹ above.

R⁵ and R⁷ each independently represent —OCOR^{r3} or —OR^{r4}. R^{r3} represents a hydrogen atom, an alkyl group optionally having a substituent, an unsaturated aliphatic hydrocarbon group optionally having a substituent, or an aryl group optionally having a substituent. R^{r4} represents an alkyl group optionally having a substituent, an unsaturated aliphatic hydrocarbon group optionally having a substituent, or an aryl group optionally having a substituent.

Examples of R^{r3} and R^{r4} include those of the groups represented by R^{r1} and R^{r2}.

Examples of R⁵ and R⁷ include those of the group represented by R².

When a plurality of R⁴s are present, the R⁴s may be the same or different. When a plurality of R⁵s are present, the R⁵s may be the same or different. When a plurality of R⁶s are present, the R⁶s may be the same or different. When a plurality of R⁷s are present, the R⁷s may be the same or different.

L represents a single bond or a divalent linking group.

Examples of the divalent linking group include alkylene groups and arylene groups.

n2+m2 and n3+m3 each independently represent the valence of the metal atom represented by M-1.

Other examples of the specific metal compound include a compound represented by formula (4), hydrolysates thereof, and condensates of the hydrolysates.

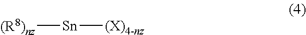

In formula (4), R⁸ represents a hydrocarbon group optionally having a substituent.

Examples of the hydrocarbon group include those of the group represented by R¹.

X represents a hydrolyzable group. nz represents 1 or 2.

Examples of X include —NHR^{x1}, —NR^{x1}R^{x2}, —OSiR^{x1}R^{x2}R^{x3}, —N(SiR^{x1}₃)(R^{x2}), —N(SiR^{x1}₃)(SiR^{x2}₃), an azido group, —C≡CR^{x1}, —NH(COR^{x1}), —NR^{x1}(COR^{x2}), —NR^{x1}C(NR^{x2})R^{x3} (an amidinate group), and an imido group, and —NHR^{x1} or —NR^{x1}R^{x2} is preferred. R^{x1} to R^{x3} each independently represent a hydrocarbon group having 1 to 10 carbon atoms. R^{x1} to R^{x3} are each preferably an alkyl group having 1 to 10 carbon atoms.

When a plurality of R⁸s are present, the R⁸s may be the same or different. When a plurality of Xs are present, the Xs may be the same or different.

The specific metal compound is preferably a compound represented by formula (5).

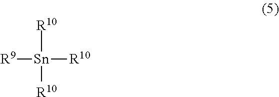

In formula (5), R⁹ represents an alkyl group optionally having a substituent, an unsaturated aliphatic hydrocarbon group optionally having a substituent, or an aryl group optionally having a substituent. R¹⁰ represents —OCOR^{r5} or —OR^{r6}. R^{r5} represents a hydrogen atom, an alkyl group optionally having a substituent, an unsaturated aliphatic hydrocarbon group optionally having a substituent, or an aryl group optionally having a substituent. R^{r6} represents an alkyl group optionally having a substituent, an unsaturated aliphatic hydrocarbon group optionally having a substituent, or an aryl group optionally having a substituent.

R⁹, R¹⁰, R^{r5}, and R^{r6} are the same as R¹, R², R^{r1}, and R^{r2}, respectively, in formula (1), and their preferred forms are also the same as those of R¹, R², R^{r1}, and R^{r2} in formula (1).

The plurality of R¹⁰s present may be the same or different.

The specific metal compound includes preferably at least one selected from the group consisting of the compound represented by formula (1), the compound represented by formula (2), and condensates thereof, includes more preferably at least one selected from the group consisting of the compound represented by formula (5), the compound represented by formula (2), and condensates thereof, and includes still more preferably at least one selected from the group consisting of the compound represented by formula (2) and condensates thereof.

Other examples of the specific metal compound include specific metal compounds described in JP2021-047426A, JP2021-179606A, JP6805244B, and WO2019/111727A.

One specific metal compound may be used alone, or a combination of two or more may be used.

The content of the specific metal compound is preferably 50 to 100% by mass and more preferably 80 to 100% by mass based on the total solid amount of the metal resist composition.

### Organic Acid

The metal resist composition may contain an organic acid.

Examples of the organic acid include carboxylic acids, sulfonic acids, sulfinic acids, organic phosphinic acids, organic phosphonic acids, phenols, enols, thiols, imidic acids, oximes, and sulfonamides. Of these, carboxylic acids are preferred.

Examples of the carboxylic acid include: monocarboxylic acids such as formic acid, propionic acid, butanoic acid, pentanoic acid, hexanoic acid, heptanoic acid, octanoic acid, nonanoic acid, decanoic acid, 2-ethylhexanoic acid, oleic acid, acrylic acid, methacrylic acid, trans-2,3-dimethylacrylic acid, stearic acid, linoleic acid, linolenic acid, arachidonic acid, salicylic acid, benzoic acid, p-aminobenzoic acid, monochloroacetic acid, dichloroacetic acid, trichloroacetic acid, trifluoroacetic acid, pentafluoropropionic acid, gallic acid, and shikimic acid; dicarboxylic acids such as oxalic acid, malonic acid, maleic acid, methyl malonic acid, fumaric acid, adipic acid, sebacic acid, phthalic acid, and tartaric acid; and carboxylic acids having three or more carboxy groups such as citric acid.

Examples of the organic acid that can be contained in the metal resist composition include those that can be contained in the composition.

One organic acid may be used alone, or a combination of two or more may be used.

The content of the organic acid is preferably 0 to 10% by mass and more preferably 1 to 5% by mass based on the total solid amount of the metal resist composition.

### Organic Solvent

The metal resist composition may contain an organic solvent. Examples of the organic solvent include ketone-based solvents, ester-based solvents, alcohol-based solvents, amide-based solvents, ether-based solvents, and hydrocarbon-based solvents.

Examples of the ketone-based solvent include 1-octanone, 2-octanone, 1-nonanone, 2-nonanone, acetone, 2-heptanone, 4-heptanone, 1-hexanone, 2-hexanone, diisobutyl ketone, cyclohexanone, methylcyclohexanone, phenylacetone, methyl ethyl ketone, methyl isobutyl ketone, acetylacetone, acetonylacetone, ionone, diacetonyl alcohol, acetylcarbinol, acetophenone, methyl naphthyl ketone, isophorone, and propylene carbonate. Of these, cyclohexanone, 2-heptanone, or diisobutyl ketone is preferred.

Examples of the ester-based solvent include methyl acetate, butyl acetate, ethyl acetate, propyl acetate, isopropyl acetate, pentyl acetate, isopentyl acetate, hexyl acetate, ethylene glycol monoethyl ether acetate, diethylene glycol monobutyl ether acetate, diethylene glycol monoethyl ether acetate, ethyl-3-ethoxypropionate, 3-methoxybutyl acetate, 1-methoxy-2-propyl acetate, 3-methyl-3-methoxybutyl acetate, methyl formate, ethyl formate, butyl formate, propyl formate, ethyl lactate, butyl lactate, propyl lactate, butyl butyrate, methyl 2-hydroxyisobutyrate, isoamyl butyrate, isobutyl isobutyrate, ethyl propionate, propyl propionate, butyl propionate, and isobutyl propionate. Of these, propyl acetate, butyl acetate, hexyl acetate, ethyl lactate, isoamyl butyrate, ethyl propionate, propyl propionate, butyl propionate, or isobutyl propionate is preferred.

Examples of the alcohol-based solvent include methyl alcohol, ethyl alcohol, n-propyl alcohol, isopropyl alcohol, n-butyl alcohol, sec-butyl alcohol, tert-butyl alcohol, isobutyl alcohol, n-hexyl alcohol, 4-methyl-2-pentanol, n-heptyl alcohol, n-octyl alcohol, n-decanol, ethylene glycol, diethylene glycol, triethylene glycol, propylene glycol, ethylene glycol monomethyl ether, ethylene glycol monoethyl ether, propylene glycol monoethyl ether, diethylene glycol monomethyl ether, triethylene glycol monoethyl ether, and methoxymethylbutanol.

Examples of the amide-based solvent include N,N-dimethylformamide, 1-methyl-2-pyrrolidone, 2-pyrrolidinone, 1,3-dimethyl-2-imidazolidinone, 2-pyrrolidinone, ε-caprolactam, formamide, N-methylformamide, acetamide, N-methylacetamide, N,N-dimethylacetamide, N-methylpropanamide, and hexamethylphosphoric triamide.

Examples of the ether-based solvent include dioxane, tetrahydrofuran, anisole, and diisobutyl ether. Of these, diisobutyl ether is preferred.

Examples of the hydrocarbon-based solvent include: saturated aliphatic hydrocarbon-based solvents such as pentane, hexane, octane, nonane, decane, undecane, dodecane, hexadecane, 2,2,4-trimethylpentane, and 2,2,3-trimethylhexane; and aromatic hydrocarbon-based solvents such as mesitylene, cumene, pseudocumene, 1,2,4,5-tetramethylbenzene, p-cymene, toluene, xylene, ethylbenzene, propylbenzene, 1-methylpropylbenzene, 2-methylpropylbenzene, dimethylbenzene, diethylbenzene, ethylmethylbenzene, trimethylbenzene, ethyldimethylbenzene, and dipropylbenzene. Of these, saturated aliphatic hydrocarbon-based solvents are preferred, and octane, nonane, decane, undecane, or dodecane is more preferred.

### Additional Additives

The metal resist composition may contain additional additives such as a surfactant, water, a dissolution inhibiting compound, a dye, a plasticizer, a photosensitizer, a light-absorbing agent, and a compound that increases solubility in the developer (e.g., a phenol compound having a molecular weight of 1000 or less or an alicyclic or aliphatic compound having a carboxylic acid group).

The surfactant is preferably a fluorine-based surfactant or a silicon-based surfactant. For example, surfactants described in paragraphs [0218] and [0219] of WO2018/193954A can be used.

### Step 2

Step 2 is the step of exposing the metal resist film to light. The entire metal resist film may be exposed to light, or the metal resist film may be exposed to light in a pattern.

Preferably, step 2 is the step of exposing the metal resist film to light in a pattern through a photomask.

The photomask is, for example, any well-known photomask. The photomask may be in contact with the metal resist film.

Examples of the light to which the metal resist film is exposed include infrared light, visible light, ultraviolet light, far-ultraviolet light, extreme ultraviolet (EUV) light, X rays, and electron beams.

The wavelength of the exposure light is preferably 250 nm or less, more preferably 220 nm or less, and still more preferably 1 to 200 nm. Specifically, the light is preferably KrF excimer laser light (wavelength: 248 nm), ArF excimer laser light (wavelength: 193 nm), F₂ excimer laser light (wavelength: 157 nm), X rays, EUV light (wavelength: 13 nm), or an electron beam, more preferably KrF excimer laser light, ArF excimer laser light, EUV light, or an electron beam, and still more preferably EUV light or an electron beam.

No particular limitation is imposed on the amount of light exposure so long as the solubility of the metal resist film exposed to light in the developer containing the organic solvent decreases.

The light exposure method may be liquid immersion exposure.

Step 2 may be performed once or two or more times.

### Step 3

Step 3 is the step of subjecting the light-exposed metal resist film to developing treatment using a developer. In the developing treatment, unexposed portions of the light-exposed metal resist film are removed, and a pattern is thereby formed.

The developing method used may be any well-known developing method. Specific examples of the developing method include: a method (dipping method) in which the light-exposed metal resist film is immersed in a bath filled with the developer for a prescribed time; a method (puddle method) in which the developer is placed on the surface of the light-exposed metal resist film so as to form a convex puddle due to surface tension and left to stand for a prescribed time to develop the metal resist film; a method (spraying method) in which the developer is sprayed onto the surface of the light-exposed metal resist film; and a method (dynamic dispensing method) in which the developer is continuously dispensed onto a constantly rotating substrate with the light-exposed metal resist film disposed thereon while a nozzle from which the developer is discharged is moved.

After the developing step, the step of terminating the development using a solvent other than the developer may be performed.

The developing time is preferably 10 to 300 seconds and more preferably 20 to 120 seconds.

The temperature of the developer during development is preferably 0 to 50° C. and more preferably 15 to 35° C.

### Developer

The chemical solution of the invention can be used as the developer in step 3.

When the pattern forming method does not include step 4 described later or when the pattern forming method includes step 4 described later and the rinsing liquid in step 4 is an additional chemical solution different from the chemical solution, the developer in step 3 is preferably the chemical solution of the invention described above.

When the pattern forming method includes step 4 described later and the rinsing liquid in step 4 is the chemical solution of the invention, the developer in step 3 may be the chemical solution of the invention described above or may be an additional chemical solution different from the chemical solution of the invention.

The additional chemical solution used differs from the chemical solution of the invention described above and can be any well-known developer or any well-known rinsing liquid.

The additional chemical solution contains an organic solvent. Examples of the organic solvent contained in the additional chemical solution include ketone-based solvents, ester-based solvents, alcohol-based solvents, amide-based solvents, ether-based solvents, and hydrocarbon-based solvents. Specific examples include organic solvents that may be contained in the metal resist.

The additional chemical solution may contain one organic solvent alone or may contain a combination of two or more organic solvents.

The additional chemical solution may contain an organic solvent different from those described above, water, a surfactant, etc.

### Step 4

Step 4 is the step of washing the pattern obtained in step 3 (developing step) with a rinsing liquid.

Examples of the rinsing method are the same as those of the developing method in step 3 (such as the dipping method, the puddle method, the spraying method, and the dynamic dispensing method).

The treatment time is preferably 10 to 300 seconds and more preferably 10 to 120 seconds.

The temperature of the rinsing liquid is preferably 0 to 50° C. and more preferably 15 to 35° C.

### Rinsing Liquid

When the developer in step 3 is the additional chemical solution, it is preferable that the rinsing liquid in step 4 is the chemical solution of the invention described above.

When the developer in step 3 is the chemical solution of the invention described above, the rinsing liquid in step 4 may be the chemical solution of the invention described above or may be the additional chemical solution.

Examples of the additional chemical solution that can be used as the rinsing liquid are the same as those of the chemical solution that can be used as the developer, and preferred forms of the additional chemical solution are also the same as those of the chemical solution that can be used as the developer.

### Additional Steps

The pattern forming method may further include additional steps other than steps 1 to 4.

Examples of the additional steps include a post-exposure baking step, a post-baking step, an etching step, and a purification step.

### Post-Exposure Baking Step

Preferably, the pattern forming method includes, after step 2 (the light exposure step) but before step 3 (the developing step), a post-exposure baking (PEB) step.

The heating temperature for the post-exposure baking is preferably 80 to 200° C., more preferably 80 to 180° C., and still more preferably 80 to 150° C. The heating time is preferably 10 to 1000 seconds, more preferably 10 to 180 seconds, and still more preferably 30 to 120 seconds.

The post-exposure baking may be performed using means included with a well-known exposing device and/or a well-known developing device and a hot plate. The post-exposure baking may be performed once or two or more times.

### Post-Baking Step

Preferably, the pattern forming method includes, after step 4 (the rinsing step), the step of heating the pattern (the post-baking step). With the post-baking (PB) step, the developer and the rinsing liquid remaining between traces of the pattern and inside the pattern can be removed, and the surface roughness of the pattern can be improved.

The heating temperature in the post-baking step is preferably 40 to 250° C. and more preferably 80 to 200° C.

The heating time in the post-baking step is preferably 10 to 180 seconds and more preferably 30 to 120 seconds.

### Etching Step

The pattern forming method may include the etching step of etching the substrate using the formed pattern as a mask.

The etching method used may be any well-known etching method. Specific examples include a method described in Proceedings of Society of Photo-Optical Instrumentation Engineers (Proc. Of SPIE) Vol. 6924, 692420 (2008), a method described in “Chapter 4 Etching” in “Semiconductor Process Text Book, 4th Ed., published in 2007, publisher: SEMI Japan,” and a method described in JP2009-267112A.

### Purification Step

The pattern forming method may include the purification step of purifying the metal resist composition, the developer, the rinsing liquid, and/or other various components (such as the composition for forming the undercoat film and the composition for forming the topcoat) used for the pattern forming method.

The purification method is, for example, a well-known purification method and is preferably filtering or a method using an adsorbent.

### Method for Producing Electronic Device

A method for producing an electronic device incudes the step of using the above-described chemical solution of the invention. A preferred form of the method for producing an electronic device is an electronic device production method including the step of forming a pattern using the chemical solution of the invention according to the pattern forming method described above.

The electronic device is suitably installed in electric and electronic devices (such as household electrical appliances, OA (Office Automation) devices, media-related devices, optical devices, and communication devices).

### EXAMPLES

The present invention will be further described in detail by way of Examples.

Materials, amounts used, ratios, treatment details, treatment procedures, etc. shown in the following Examples can be appropriately changed so long as they do not depart from the gist of the invention. Therefore, the scope of the present invention should not be construed as limited to the following Examples.

### Preparation of Raw Materials

2-Heptanone, carbonyl compounds, and cycloalkane compounds were synthesized and/or purified according to the following procedures.

### Synthesis and Purification of 2-Heptanone

A well-known alkyne hydration reaction was used to synthesize 2-heptanone. Specifically, 1-heptyne, water, sulfuric acid, and mercury sulfate were mixed in amounts listed below, and the obtained mixture was stirred to subject 1-heptyne to the hydration reaction (addition of water). 1-Hepten-2-ol generated by the hydration reaction was subjected to keto-enol tautomerism to thereby obtain an unpurified product containing 2-heptanone.
1-Heptyne (manufactured by TOKYO CHEMICAL INDUSTRY Co., Ltd.): 100 parts by mass (g)
Water (ultrapure water): 30 parts by mass (g)
Sulfuric acid (manufactured by FUJIFILM Wako Pure Chemical Corporation): 10 parts by mass (g)
Mercury sulfate (manufactured by FUJIFILM Wako Pure Chemical Corporation): 10 parts by mass (g)

The obtained unpurified product was subjected to dewatering treatment by a column method using a molecular sieve 3A (manufactured by FUJIFILM Wako Pure Chemical Corporation).

Next, the unpurified product subjected to the dewatering treatment was subjected to distillation purification using a distillation column in which a first plate distillation column (the theoretical number of plates: 150) including no pressure reduction mechanism and a second plate distillation column (the theoretical number of plates: 150) including a pressure reduction mechanism were connected in series. Specifically, the distillation purification was performed sequentially from the first plate distillation column.

Then, a filtration device including a circulation passage composed of the following ion exchange resin and filters connected in series from the upstream side and further including a return passage for returning the unpurified product from the most downstream side of the circulation passage to the most upstream side was used to subject the unpurified product subjected to the distillation purification to circulating filtration purification. The number of circulation cycles was 50.

The details of the members in the filtration device are shown below in the order from the upstream side.
Anion exchange resin (an anion exchange resin described in Production Example 1 in paragraph 0028 of JP2009-155208A)
Ion exchange filter (IonKleen SL manufactured by Pall Corporation)
Nylon filter (Asymmetric manufactured by Pall Corporation, pore size: 5 nm)
UPE filter (Purasol SP/SN solvent purifier manufactured by Entegris)
PTFE filter (XpressKLEEN manufactured by Pall Corporation, pore size: 3 nm)
UPE filter (Microgard manufactured by Entegris, pore size: 3 nm)

In the circulating filtration purification, the operation in which the unpurified product is caused to pass from the most upstream purification member to the most downstream purification member is counted as one circulation cycle.

### Purification of Carbonyl Compounds and Cycloalkane Compounds

The following compounds were prepared as carbonyl compounds and cycloalkane compounds. The following compounds used were all semiconductor-grade compounds or high-purity grade compounds corresponding to the semiconductor-grade compounds.

### (Carbonyl Compounds (Ketones))

4-Heptanone (C₇H₁₄O) (manufactured by FUJIFILM Wako Pure Chemical Corporation)
5-Methyl-2-hexanone (C₇H₁₄O) (manufactured by TOKYO CHEMICAL INDUSTRY Co., Ltd.)
5-Methyl-3-hexanone (C₇H₁₄O) (manufactured by TOKYO CHEMICAL INDUSTRY Co., Ltd.)
3-Heptanone (C₇H₁₄O) (manufactured by FUJIFILM Wako Pure Chemical Corporation)
Cyclopentanone (C₅H8O) (manufactured by FUJIFILM Wako Pure Chemical Corporation)
2-Pentanone (C₅H₁₀O) (manufactured by FUJIFILM Wako Pure Chemical Corporation)
3-Pentanone (C₅H₁₀O) (manufactured by FUJIFILM Wako Pure Chemical Corporation)

### (Carbonyl Compounds (Aldehydes))

2-Methylhexanal (C₇H₁₄O) (manufactured by BOC Science)
2-Ethyl-3-methylbutanal (C₇H₁₄O) (manufactured by Sigma-Aldrich)
2-Ethylhexanal (C₈H16O) (manufactured by TOKYO CHEMICAL INDUSTRY Co., Ltd.)
1-Pentanal (C₅H₁₀O) (manufactured by TOKYO CHEMICAL INDUSTRY Co., Ltd.) (Cycloalkane compounds)
1-Methyl-4-isopropylcyclohexane (manufactured by FUJIFILM Wako Pure Chemical Corporation)
1-Methyl-2-isopropylcyclohexane (manufactured by FUJIFILM Wako Pure Chemical Corporation)
1-Methyl-3-isopropylcyclohexane (manufactured by FUJIFILM Wako Pure Chemical Corporation)

For each of the above unpurified compounds, a filtration device including a circulation passage composed of the following filters connected in series from the upstream side and further including a return passage for returning the unpurified product from the most downstream side of the circulation passage to the most upstream side was used to subject the unpurified product to circulating filtration purification. The number of circulation cycles was 50.

The details of the members in the filtration device are shown below in the order from the upstream side.
Ion exchange filter (IonKleen SL manufactured by Pall Corporation)
Nylon filter (Asymmetric manufactured by Pall Corporation, pore size: 5 nm)
UPE filter (Purasol SP/SN solvent purifier manufactured by Entegris)
PTFE filter (XpressKLEEN manufactured by Pall Corporation, pore size: 3 nm)
UPE filter (Microgard manufactured by Entegris, pore size: 3 nm)

Each of the compounds subjected to the circulating filtration purification was further subjected to distillation purification using the same method as that for 2-heptanone.

In the manner described above, 2-heptanone, the carbonyl compounds, and the cycloalkane compounds were obtained, in which the content of water had been reduced to the detection limit or lower and the contents of the Mn atoms and Fe atoms were each 0.0001 ppt by mass or less. The total content of the specific carbonyl compounds and the total content of the specific cycloalkane compounds in the 2-heptanone obtained were less than their detection limits.

In the 2-heptanone, carbonyl compounds, and cycloalkane compounds obtained, the contents of organic compounds other than 2-heptanone, the specific carbonyl compounds, and the cycloalkane compound and the contents of inorganic acids such as sulfuric acid were less than their detection limits.

The content of water was measured using the above-described Karl Fischer moisture meter (product name: “MKC-710M” manufactured by Kyoto Electronics Manufacturing Co., Ltd., Karl Fischer coulometric titration type). The limit of detection of the water content by this device was 1 ppm by mass.

The contents of Mn atoms and Fe atoms were measured using the above-described ICP-MS (device used: Agilent 8900 triple quadrupole ICP-MS). The limit of detection of Mn atoms by this device was 0.02 ppt by mass (unconcentrated), and the limit of detection of Fe atoms was 0.24 ppt by mass (unconcentrated).

The content of the carbonyl compound and the content of the cycloalkane compound were measured using a combination of the above-described gas chromatograph “7890B” (manufactured by Agilent) and the above-described mass spectrometer “JMS-Q1500” (manufactured by JEOL Ltd.). The limit of detection of the content of the carbonyl compound by this device was 0.1 ppm by mass, and the limit of detection of the content of the cycloalkane compound was 1 ppb by mass. The limits of detection of other organic compounds were 0.1 ppm by mass.

The contents of inorganic acids such as sulfuric acid were measured using a gas chromatograph (product name: “GCMS-2020” manufactured by Shimadzu Corporation). The limits of detection of the inorganic acids were 0.001 ppm by mass.

The contents of Mn atoms and the contents of Fe atoms in 2-heptanone, the carbonyl compounds, and the cycloalkane compounds were measured. Specifically, these compounds were concentrated in the same manner as in a method for the chemical solution described later, and then the contents were measured using the device described above. The contents of Mn atoms were found to be 0.0001 ppt by mass or less, and the contents of Fe atoms were found to be 0.0001 ppt by mass or less.

The contents of transition elements other than the Mn and Fe atoms that were measurable by ICP-MS in the 2-heptanone, carbonyl compounds, and cycloalkane compounds obtained were measured using the device described above after these compounds were concentrated by the same method as that for the chemical solution described later. The contents of the transition elements were all less than 0.0001 ppt by mass.

### Preparation of Chemical Solutions

One of the carbonyl compounds obtained by the method described above, ultrapure water, a Mn atom source, an Fe atom source, and optionally one of the cycloalkane compounds obtained by the method described above and included in some compositions were added all at once or in portions to the 2-heptanone obtained by the method described above such that a chemical composition shown in one of the following tables was obtained. Chemical solutions in Examples and Comparative Examples were thereby prepared.

The content of Mn atoms, the content of Fe atoms, and the total content of transition metals other than Mn and Fe atoms in the ultrapure water used to prepare the chemical solutions were found to be the same as their contents in 2-heptanone etc.

The Mn atom source was added using a method in which powdery nanoparticles of Mn nanoparticles (S series manufactured by Forward Science Laboratory) with their concentration adjusted to a prescribed value were added to each chemical solution.

The Fe atom source was added using a method in which an aqueous solution of Fe nanoparticles (manufactured by Sigma-Aldrich, particle diameter: 10 nm) with their concentration adjusted to a prescribed value was added to each chemical solution.

The content of Mn atoms in each chemical solution was quantified according to the following procedure.

First, the chemical solution used for the quantification of the content of Mn atoms was heated under reflux conditions at 160 to 180° C. to remove the organic solvent and water contained in the chemical solution, and the non-volatile components contained in the chemical solution were thereby concentrated. The content of Mn atoms contained in the concentrated solution was quantified using the device described above.

When the non-volatile components were concentrated, the contents of Mn atoms in different chemical solutions with concentration factors ranging from 10 to 1000 were computed. Then positive correlation was found between the concentration factor and the Mn atom content, and the coefficient of determination (R²) in linear regression was found to be more than 0.98. Specifically, when a chemical solution is concentrated using the method described above, the content of Mn atoms contained in the chemical solution can be quantified.

The content of Fe atoms and the contents of transition elements other than Mn and Fe atoms that were measurable by ICP-MS were also quantified using the procedure described above.

### Preparation of Metal Resist Composition

Monobutyltin oxide hydrate (BuSnOOH) powder (0.209 g, TCI America) was added to 4-methyl-2-pentanol (10 mL) to prepare a metal resist precursor solution. The solution was placed in a closed vial and stirred for 24 hours. The resulting mixture was subjected to centrifugation at 4000 rpm for 15 minutes and filtrated using a 0.45 μm PTFE syringe filter to remove insoluble materials, and a metal resist composition was thereby obtained.

The organic solvent in the metal resist composition was removed, and the resulting metal resist composition was fired at 600° C. The content of Sn determined from the remaining mass of SnO₂ was 0.093M.

The metal resist precursor solution was subjected to DLS (Dynamic Light Scattering) analysis using a Moebius device (manufactured by Wyatt Technology). The results were consistent with a unimodal distribution of particles having an average particle diameter of 2 nm and also consistent with the reported diameter of dodecameric butyltin hydroxide oxide polyatomic cations (Eychenne-Baron et al., Organometallics, 19, 1940-1949 (2000)).

### Evaluation

### Capability of Preventing Occurrence of Defects Caused by Water

Each of the chemical solutions in the Examples and Comparative Examples was used as a metal resist washing liquid (resist remover).

The metal resist composition (2.5 mL) prepared as described above was applied to a silicon wafer with a diameter of 12 inches to form a Sn resist film by spin coating. Next, one of the chemical solutions (10 mL) in the Examples and Comparative Examples was applied to the Sn resist film, and the silicon wafer was rotated at 1500 rpm for 45 seconds to dryness. This washing procedure was repeated 10 times. Then a surface defect inspection system (SurfScan SP7 manufactured by KLA) was used to irradiate the surface of the silicon wafer with laser light, and the scattered light was measured to obtain the information about the coordinates of the positions of defects on the silicon wafer. Next, the shapes of the measured defects were evaluated using a defect review system (SEM Vision G7E manufactured by Applied Materials). The defect images obtained using the defect review system were used to identify stain-like defects and foreign material-like defects based on modes of the device. Flat defects having no irregularities, containing no foreign materials, and showing contrast differences from other regions on the wafer surface were identified as stain-like defects, and defects in the form of foreign materials adhering to the wafer were identified as foreign material-like defects.

The number of stain-like defects and the number of foreign material-like defects on the silicon wafer were counted. The numbers of defects were used to evaluate the capability of preventing the occurrence of stain-like defects and the capability of preventing the occurrence of foreign material-like defects according to the following evaluation criteria.

The smaller the numbers of defects, the better.

### Evaluation Criteria for Stain Defects

A: The number of stain defects is 5 or less.
B: The number of stain defects is more than 5 and 10 or less.
C: The number of stain defects is more than 10 and 50 or less.
D: The number of stain defects is more than 50.

### Evaluation Criteria for Foreign Material Defect

A: The number of foreign material defects is 5 or less.
B: The number of foreign material defects is more than 5 and 10 or less.
C: The number of foreign material defects is more than 10 and 50 or less.
D: The number of foreign material defects is more than 50.

### In-Plane Cleanliness Uniformity

In the same manner as that in [Capability of preventing occurrence of defects caused by water] described above, the metal resist composition (2.5 mL) was applied to a silicon wafer with a diameter of 12 inches to form a Sn resist film by spin coating. Next, one of the chemical solutions (10 mL) in the Examples and Comparative Examples was applied to the Sn resist film, and the silicon wafer was rotated at 1500 rpm for 45 seconds to dryness. This washing procedure was repeated 10 times.

Next, a vapor phase decomposition-inductive coupling plasma mass spectrometer (VPD-ICP-MS manufactured by Chem Trace) was used to measure the amount of residual Sn (atoms/cm²) at randomly selected 20 points on the surface of the silicon wafer. The measurement values of the amount of residual Sn at the 20 points were used to compute the standard deviation σ of the amount of residual Sn. The 3σ value obtained by multiplying the computed standard deviation o by 3 was used to evaluate the in-plane cleanliness uniformity after the metal resist was washed with the chemical solution according to the following evaluation criteria. The smaller the numerical value of 3σ, the smaller the nonuniformity in the cleanliness on the surface of the silicon wafer after the metal resist was washed (removed), and the better.

### Evaluation Criteria for In-Plane Cleanliness Uniformity

A: 3σ is less than 1×10⁹ atom/cm².
B: 3σ is 1×10⁹ atom/cm² or more and less than 2.5×10⁹ atom/cm2.
C: 3σ is 2.5×10⁹ atom/cm² or more and less than 5×10⁹ atom/cm².
D: 3σ is 5×10⁹ atom/cm² or more.

### Wafer Bevel Cleanliness

In the same manner as that in [Capability of preventing occurrence of defects caused by water] described above, the metal resist composition (2.5 mL) was applied to a silicon wafer with a diameter of 12 inches to form a Sn resist film by spin coating. Next, one of the chemical solutions (10 mL) in the Examples and Comparative Examples was applied to the Sn resist film, and the silicon wafer was rotated at 1500 rpm for 45 seconds to dryness. This washing procedure was repeated 10 times.

Next, a vapor phase decomposition-inductive coupling plasma mass spectrometer (VPD-ICP-MS manufactured by Chem Trace) was used to measure the amount of residual Sn (atoms/cm²) on the surface of a beveled portion of the silicon wafer. The amount of residual Sn was determined by measuring the amount of Sn at randomly selected 20 points on the surface of the beveled portion and computing the arithmetic mean of the obtained measurement values.

The measured amount of residual Sn on the beveled portion was used to evaluate the cleanliness of the wafer bevel washed with the chemical solution according to the following evaluation criteria. The smaller the amount of residual Sn, the higher the capability of washing out (removing) the metal resist on the beveled portion of the silicon wafer, and the better.

### Evaluation Criteria for Wafer Bevel Cleanliness

S: The amount of residual Sn is 1×10¹⁰ atom/cm² or less.
A: The amount of residual Sn is more than 1×10¹⁰ atom/cm² and 5×10¹⁰ atom/cm² or less.
B: The amount of residual Sn is more than 5×10¹⁰ atom/cm² and 1×10¹¹ atom/cm² or less.
C: The amount of residual Sn is more than 1×10¹¹ atom/cm² and 5×10¹¹ atom/cm² or less.
D: The amount of residual Sn is more than 5×10¹¹ atom/cm².

### Residual Organic Substances After Baking

One of the chemical solutions (10 mL) in the Examples and Comparative Examples was applied to a silicon wafer with a diameter of 12 inches, and the silicon wafer was rotated at 1500 rpm for 45 seconds to dryness. Next, a silicon wafer analyzer-gas chromatography-mass spectrometer (SWA-GC/MS “6890N/5973B” manufactured by Agilent Technologies Japan, Ltd.) was used to measure the amount of residual organic substances (unit: ng/wafer) on the surface of the silicon wafer.

Separately, one of the chemical solutions (10 mL) in the Examples and Comparative Examples was applied to another silicon wafer with a diameter of 12 inches, and the silicon wafer was rotated at 1500 rpm for 45 seconds to dryness. Next, the obtained silicon wafer was subjected to baking treatment at 150° C. for one minute. Then the silicon wafer analyzer-gas chromatography-mass spectrometer (SWA-GC/MS “6890N/5973B”) was used to measure the amount of residual organic substances (unit: ng/wafer) on the surface of the baked silicon wafer.

The ratio of the amount of residual organic substances measured on the surface of the baked silicon wafer to the amount of residual organic substances measured on the surface of the unbaked silicon wafer was computed (this ratio is referred to as the ratio of residual organic substances). The computed ratio of residual organic substances was used to evaluate the residual organic substances derived from the chemical solution on the baked silicon wafer according to the following evaluation criteria. The smaller that ratio of the residual organic substances, the larger the amount of organic substances removed from the surface of the silicon wafer by the baking treatment, and the better.

### Evaluation Criteria for Residual Organic Substances After Baking

S: The ratio of residual organic substances is less than 20%.
A: The ratio of residual organic substances is 20% or more and less than 40%.
B: The ratio of residual organic substances is 40% or more and less than 60%.
C: The ratio of residual organic substances is 60% or more.

### Capability of Reducing Contamination With Organic Substances on Wafer After Washing

A silicon wafer with a diameter of 12 inches was left to stand in a clean room compliant with class 10 according to the Federal Standards [Fed. Std. 209D] (equivalent to ISO class 4 described above) for 1 hour, and then the SWA-GC/MS (“6890N/5973B” manufactured by Agilent Technologies Japan, Ltd.) was used to measure the amount of residual organic substances on the surface of the silicon wafer (unit: ng/wafer).

Separately, in the clean room, one of the chemical solutions (10 mL) in the Examples and Comparative Examples was applied to another silicon wafer with a diameter of 12 inches, and the silicon wafer was rotated at 1500 rpm for 45 seconds to dryness. This washing procedure was repeated 10 times. Then the SWA-GC/MS was used to measure the amount of residual organic substances on the surface of the silicon wafer.

The amount of residual organic substances (residual organic substance amount 1) measured on the silicon wafer not subjected to the washing treatment with the chemical solution and the amount of residual organic substances (residual organic substance amount 2) measured on the silicon wafer subjected to the washing treatment with the chemical solution were used to compute the reduction ratio of the amount of residual organic substances by the washing treatment using the following formula.

Reduction ratio of amount of residual organic substances=(residual organic substance amount 1-residual organic substance amount 2)/(residual organic substance amount 1)

The computed reduction ratio of the amount of residual organic substances was used to evaluate the capability of reducing the contamination with the organic substances after the wafer was washed with the chemical solution according to the following evaluation criteria. The larger the ratio, the smaller the amount of the organic substances adhering to the surface of the silicon wafer washed with the chemical solution, and the better.

### Evaluation Criteria for Capability of Reducing Contamination With Organic Substances

SS: The reduction ratio of the amount of residual organic substances is 20% or more.
S: The reduction ratio of the amount of residual organic substances is 15% or more and less than 20%.
A: The reduction ratio of the amount of residual organic substances is 10% or more and less than 15%.
B: The reduction ratio of the amount of residual organic substances is 5% or more and less than 10%.
C: The reduction ratio of the amount of residual organic substances is less than 5%.

### Capability of Preventing Occurrence of Defects Derived From Chemical Solution

A silicon wafer with a diameter of 12 inches was prepared. A surface defect inspection system (SurfScan SP7 manufactured by KLA) was used to irradiate the surface of the silicon substrate with laser light, and the scattered light was measured to determine the positions of defects on the silicon wafer and their sizes.

One of the chemical solutions (10 mL) in the Examples and Comparative Examples was applied to the silicon wafer using a coater/developer (CLEAN TRACK LITHIUS PRO Z manufactured by Tokyo Electron Ltd.). Then spin drying was performed at 2000 rpm for 30 seconds, and the surface defect inspection system (SurfScan SP7 manufactured by KLA) was used to measure the positions of defects on the silicon wafer and their sizes by the method described above.

The positions of the defects, the numbers of defects, and their sizes before and after the application of the chemical solution were used to extract defects derived from the chemical solution, and the capability of preventing the occurrence of defects derived from the chemical solution was evaluated according to the following evaluation criteria.

The smaller the number of defects derived from the chemical solution, the better.

### Evaluation Criteria for Defects Derived From Chemical Solution

S: The number of defects derived from the chemical solution and having a size of 20 nm or less is 3 or less.
A: The number of defects derived from the chemical solution and having a size of 20 nm or less is more than 3 and 10 or less.
B: The number of defects derived from the chemical solution and having a size of 20 nm or less is more than 10 and 20 or less.
C: The number of defects derived from the chemical solution and having a size of 20 nm or less is more than 20.

### Results

The chemical composition of each of the chemical solutions in the Examples and Comparative Examples and the evaluation results are shown in Tables 1 to 6.

In each table, “Balance” in the “2-heptanone” column means that the balance, excluding the specific carbonyl compound, water, cycloalkane compound, Mn atoms, and Fe atoms shown in the table, is 2-heptanone. In each Example, the content of 2-heptanone was 60% by mass or more based on the total mass of the chemical solution.

In each table, “NONE” in a cell means that the compound corresponding to the cell was not detected.

In each table, the “Aldehyde/ketone ratio” column indicates the ratio of the content of the specific aldehyde to the content of the specific ketone in a chemical solution containing the specific ketone and the specific aldehyde as the specific carbonyl compounds. In each numerical value in the “Aldehyde/ketone ratio” column, the exponential term is omitted. For example, “1.0E-01” means “1.0×10^{-1.”}

In each table, “<1” in the “Water content [ppm]” column means that the content of water contained in the chemical solution was lower than the detection limit, i.e., 1 ppm by mass.

In each table, the “P value” column indicates a numerical value P computed from formula (1) represented by P=−log₁₀ (X×Y). Here, the concentration of water in a chemical solution is denoted by X mol/L, and the concentration of the specific carbonyl compound is denoted by Y mol/L.

TABLE 1

| | Chemical composition of chemical solution | | | | | | | |
|---|---|---|---|---|---|---|---|---|
| | | Carbonyl compound | | | | | Water | |
| Table 1 | 2- | | Content | | Content | Aldehyde/ | content | P |
| (1-1) | Heptanone | Type | [ppm] | Type | [ppm] | ketone ratio | [ppm] | value |
| Example 1 | Balance | 4-Heptanone | 0.25 | NONE | — | — | 1 | 9.91 |
| Example 2 | Balance | 4-Heptanone | 0.5 | NONE | — | — | 5 | 8.91 |
| Example 3 | Balance | 4-Heptanone | 1 | NONE | — | — | 10 | 8.31 |
| Example 4 | Balance | 4-Heptanone | 100 | NONE | — | — | 50 | 5.61 |
| Example 5 | Balance | 4-Heptanone | 100 | NONE | — | — | 100 | 5.31 |
| Example 6 | Balance | 4-Heptanone | 500 | NONE | — | — | 500 | 3.91 |
| Example 7 | Balance | 4-Heptanone | 1000 | NONE | — | — | 1000 | 3.31 |
| Example 8 | Balance | 4-Heptanone | 0.25 | NONE | — | — | 1 | 9.91 |
| Example 9 | Balance | 4-Heptanone | 0.5 | NONE | — | — | 5 | 8.91 |
| Example 10 | Balance | 4-Heptanone | 1 | NONE | — | — | 10 | 8.31 |
| Example 11 | Balance | 4-Heptanone | 100 | NONE | — | — | 50 | 5.61 |
| Example 12 | Balance | 4-Heptanone | 100 | NONE | — | — | 100 | 5.31 |
| Example 13 | Balance | 4-Heptanone | 500 | NONE | — | — | 500 | 3.91 |
| Example 14 | Balance | 4-Heptanone | 1000 | NONE | — | — | 1000 | 3.31 |
| Example 15 | Balance | 5-Methyl-2-hexanone | 0.25 | NONE | — | — | 1 | 9.91 |
| Example 16 | Balance | 5-Methyl-2-hexanone | 0.5 | NONE | — | — | 5 | 8.91 |
| Example 17 | Balance | 5-Methyl-2-hexanone | 1 | NONE | — | — | 10 | 8.31 |
| Example 18 | Balance | 5-Methyl-2-hexanone | 100 | NONE | — | — | 50 | 5.61 |
| Example 19 | Balance | 5-Methyl-2-hexanone | 100 | NONE | — | — | 100 | 5.31 |
| Example 20 | Balance | 5-Methyl-2-hexanone | 500 | NONE | — | — | 500 | 3.91 |
| Example 21 | Balance | 5-Methyl-2-hexanone | 1000 | NONE | — | — | 1000 | 3.31 |
| Example 22 | Balance | 5-Methyl-2-hexanone | 0.25 | NONE | — | — | 1 | 9.91 |
| Example 23 | Balance | 5-Methyl-2-hexanone | 0.5 | NONE | — | — | 5 | 8.91 |
| Example 24 | Balance | 5-Methyl-2-hexanone | 1 | NONE | — | — | 10 | 8.31 |
| Example 25 | Balance | 5-Methyl-2-hexanone | 100 | NONE | — | — | 50 | 5.61 |
| Example 26 | Balance | 5-Methyl-2-hexanone | 100 | NONE | — | — | 100 | 5.31 |
| Example 27 | Balance | 5-Methyl-2-hexanone | 500 | NONE | — | — | 500 | 3.91 |
| Example 28 | Balance | 5-Methyl-2-hexanone | 1000 | NONE | — | — | 1000 | 3.31 |
| Example 29 | Balance | 5-Methyl-2-hexanone | 0.25 | 4-Heptanone | 0.25 | — | 1 | 9.61 |
| Example 30 | Balance | 5-Methyl-2-hexanone | 0.5 | 4-Heptanone | 0.5 | — | 5 | 8.61 |
| Example 31 | Balance | 5-Methyl-2-hexanone | 1 | 4-Heptanone | 1 | — | 10 | 8.01 |
| Example 32 | Balance | 5-Methyl-2-hexanone | 100 | 4-Heptanone | 100 | — | 50 | 5.31 |
| Example 33 | Balance | 5-Methyl-2-hexanone | 100 | 4-Heptanone | 100 | — | 100 | 5.01 |
| Example 34 | Balance | 5-Methyl-2-hexanone | 500 | 4-Heptanone | 500 | — | 500 | 3.61 |
| Example 35 | Balance | 5-Methyl-2-hexanone | 1000 | 4-Heptanone | 1000 | — | 1000 | 3.01 |
| Example 36 | Balance | 4-Heptanone | 100 | 2-Methylhexanal | 0.1 | 1.0E−03 | 10 | 6.31 |
| Example 37 | Balance | 4-Heptanone | 100 | 2-Methylhexanal | 10 | 1.0E−01 | 50 | 5.57 |
| Example 38 | Balance | 4-Heptanone | 1 | 2-Methylhexanal | 10 | 1.0E+01 | 100 | 6.27 |
| Example 39 | Balance | 4-Heptanone | 1 | 2-Methylhexanal | 100 | 1.0E+02 | 500 | 4.61 |
| Example 40 | Balance | 4-Heptanone | 1 | 2-Methylhexanal | 1000 | 1.0E+03 | 1000 | 3.31 |

TABLE 2

| | Chemical composition of chemical solution | | | | | Evaluation of performance |
|---|---|---|---|---|---|---|
| | Cycloalkane compound | | Mn | Fe | | of chemical solution |
| Table 1 | | Content | content | content | Mn/Fe | Stain |
| (1-2) | Type | [ppm] | [ppm] | [ppm] | ratio | defects |
| Example 1 | NONE | — | 0.03 | 0.3 | 1.0E−01 | A |
| Example 2 | NONE | — | 0.03 | 0.3 | 1.0E−01 | A |
| Example 3 | NONE | — | 0.03 | 0.3 | 1.0E−01 | A |
| Example 4 | NONE | — | 0.03 | 0.3 | 1.0E−01 | A |
| Example 5 | NONE | — | 0.03 | 0.3 | 1.0E−01 | A |
| Example 6 | NONE | — | 0.03 | 0.3 | 1.0E−01 | B |
| Example 7 | NONE | — | 0.03 | 0.3 | 1.0E−01 | C |
| Example 8 | 1-Methyl-4- | 5.00 | 0.03 | 0.3 | 1.0E−01 | A |
| | isopropylcyclohexane | | | | | |
| Example 9 | 1-Methyl-4- | 5.00 | 0.03 | 0.3 | 1.0E−01 | A |
| | isopropylcyclohexane | | | | | |
| Example 10 | 1-Methyl-4- | 5.00 | 0.03 | 0.3 | 1.0E−01 | A |
| | isopropylcyclohexane | | | | | |
| Example 11 | 1-Methyl-4 | 5.00 | 0.03 | 0.3 | 1.0E−01 | A |
| | isopropylcyclohexane | | | | | |
| Example 12 | 1-Methyl-4 | 5.00 | 0.03 | 0.3 | 1.0E−01 | A |
| | isopropylcyclohexane | | | | | |
| Example 13 | 1-Methyl-4 | 5.00 | 0.03 | 0.3 | 1.0E−01 | B |
| | isopropylcyclohexane | | | | | |
| Example 14 | 1-Methyl-4 | 5.00 | 0.03 | 0.3 | 1.0E−01 | C |
| | isopropylcyclohexane | | | | | |
| Example 15 | NONE | — | 0.03 | 0.3 | 1.0E−01 | A |
| Example 16 | NONE | — | 0.03 | 0.3 | 1.0E−01 | A |
| Example 17 | NONE | — | 0.03 | 0.3 | 1.0E−01 | A |
| Example 18 | NONE | — | 0.03 | 0.3 | 1.0E−01 | A |
| Example 19 | NONE | — | 0.03 | 0.3 | 1.0E−01 | A |
| Example 20 | NONE | — | 0.03 | 0.3 | 1.0E−01 | B |
| Example 21 | NONE | — | 0.03 | 0.3 | 1.0E−01 | C |
| Example 22 | 1-Methyl-4- | 5.00 | 0.03 | 0.3 | 1.0E−01 | A |
| | isopropylcyclohexane | | | | | |
| Example 23 | 1-Methyl-4- | 5.00 | 0.03 | 0.3 | 1.0E−01 | A |
| | isopropylcyclohexane | | | | | |
| Example 24 | 1-Methyl-4- | 5.00 | 0.03 | 0.3 | 1.0E−01 | A |
| | isopropylcyclohexane | | | | | |
| Example 25 | 1-Methyl-4- | 5.00 | 0.03 | 0.3 | 1.0E−01 | A |
| | isopropylcyclohexane | | | | | |
| Example 26 | 1-Methyl-4- | 5.00 | 0.03 | 0.3 | 1.0E−01 | A |
| | Isopropylcyclohexane | | | | | |
| Example 27 | 1-Methyl-4- | 5.00 | 0.03 | 0.3 | 1.0E−01 | B |
| | isopropylcyclohexane | | | | | |
| Example 28 | 1-Methyl-4- | 5.00 | 0.03 | 0.3 | 1.0E−01 | C |
| | isopropylcyclohexane | | | | | |
| Example 29 | NONE | — | 0.03 | 0.3 | 1.0E−01 | A |
| Example 30 | NONE | — | 0.03 | 0.3 | 1.0E−01 | A |
| Example 31 | NONE | — | 0.03 | 0.3 | 1.0E−01 | A |
| Example 32 | NONE | — | 0.03 | 0.3 | 1.0E−01 | A |
| Example 33 | NONE | — | 0.03 | 0.3 | 1.0E−01 | A |
| Example 34 | NONE | — | 0.03 | 0.3 | 1.0E−01 | B |
| Example 35 | NONE | — | 0.03 | 0.3 | 1.0E−01 | C |
| Example 36 | NONE | — | 0.03 | 0.3 | 1.0E−01 | A |
| Example 37 | NONE. | — | 0.03 | 0.3 | 1.0E−01 | A |
| Example 38 | NONE | — | 0.03 | 0.3 | 1.0E−01 | A |
| Example 39 | NONE | — | 0.03 | 0.3 | 1.0E−01 | B |
| Example 40 | NONE | — | 0.03 | 0.3 | 1.0E−01 | C |

| | Evaluation of performance of chemical solution | | | | | |
|---|---|---|---|---|---|---|
| | | | | | Capability of | |
| | | | | Residual | reducing | Defects |
| | Foreign | In-plane | Wafer | organic | contamination | derived from |
| Table 1 | material | cleanliness | bevel | substances | with organic | chemical |
| (1-2) | defects | uniformity | cleanliness | after baking | substances | solution |
| Example 1 | C | A | B | S | C | S |
| Example 2 | B | A | A | S | C | S |
| Example 3 | A | A | A | S | C | S |
| Example 4 | A | A | S | S | C | S |
| Example 5 | A | A | S | S | C | S |
| Example 6 | A | C | S | S | C | S |
| Example 7 | A | C | S | S | C | S |
| Example 8 | C | A | B | S | SS | S |
| Example 9 | B | A | A | S | SS | S |
| Example 10 | A | A | A | S | SS | S |
| Example 11 | A | A | S | S | SS | S |
| Example 12 | A | A | S | S | SS | S |
| Example 13 | A | C | S | S | SS | S |
| Example 14 | A | C | S | S | SS | S |
| Example 15 | C | A | B | S | C | S |
| Example 16 | B | A | A | S | C | S |
| Example 17 | A | A | A | S | C | S |
| Example 18 | A | A | S | S | C | S |
| Example 19 | A | A | S | S | C | S |
| Example 20 | A | C | S | S | C | S |
| Example 21 | A | C | S | S | C | S |
| Example 22 | C | A | B | S | SS | S |
| Example 23 | B | A | A | S | SS | S |
| Example 24 | A | A | A | S | SS | S |
| Example 25 | A | A | S | S | SS | S |
| Example 26 | A | A | S | S | SS | S |
| Example 27 | A | C | S | S | SS | S |
| Example 28 | A | C | S | S | SS | S |
| Example 29 | C | A | B | S | C | S |
| Example 30 | B | A | A | S | C | S |
| Example 31 | A | A | A | S | C | S |
| Example 32 | A | A | S | S | C | S |
| Example 33 | A | A | S | S | C | S |
| Example 34 | A | C | S | S | C | S |
| Example 35 | A | C | S | S | C | S |
| Example 36 | A | A | S | S | A | S |
| Example 37 | A | A | S | S | S | S |
| Example 38 | A | A | S | S | S | S |
| Example 39 | A | B | S | S | A | S |
| Example 40 | A | C | S | S | C | S |

TABLE 3

| | Chemical composition of chemical solution | | | | | | | |
|---|---|---|---|---|---|---|---|---|
| | | Carbonyl compound | | | | Aldehyde/ | Water | |
| Table 1 | | | Content | | Content | ketone | content | P |
| (2-1) | 2-Heptanone | Type | [ppm] | Type | [ppm] | ratio | [ppm] | value |
| Example 41 | Balance | 5-Methyl-2-hexanone | 100 | 2-Methylhexanal | 0.1 | 1.0E−03 | 10 | 6.31 |
| Example 42 | Balance | 5-Methyl-2-hexanone | 100 | 2-Methylhexanal | 10 | 1.0E−01 | 50 | 5.57 |
| Example 43 | Balance | 5-Methyl-2-hexanone | 1 | 2-Methylhexanal | 10 | 1.0E+01 | 100 | 6.27 |
| Example 44 | Balance | 5-Methyl-2-hexanone | 1 | 2-Methylhexanal | 100 | 1.0E+02 | 500 | 4.61 |
| Example 45 | Balance | 5-Methyl-2-hexanone | 1 | 2-Methylhexanal | 1000 | 1.0E+03 | 1000 | 3.31 |
| Example 46 | Balance | 4-Heptanone | 100 | 2-Ethyl-3-methylbutanal | 0.1 | 1.0E−03 | 10 | 6.31 |
| Example 47 | Balance | 4-Heptanone | 100 | 2-Ethyl-3-methylbutanal | 10 | 1.0E−01 | 50 | 5.57 |
| Example 48 | Balance | 4-Heptanone | 1 | 2-Ethyl-3-methylbutanal | 10 | 1.0E+01 | 100 | 6.27 |
| Example 49 | Balance | 4-Heptanone | 1 | 2-Ethyl-3-methylbutanal | 100 | 1.0E+02 | 500 | 4.61 |
| Example 50 | Balance | 4-Heptanone | 1 | 2-Ethyl-3-methylbutanal | 1000 | 1.0E+03 | 1000 | 3.31 |
| Example 51 | Balance | 5-Methyl-2-hexanone | 100 | 2-Ethyl-3-methylbutanal | 0.1 | 1.0E−03 | 10 | 6.31 |
| Example 52 | Balance | 5-Methyl-2-hexanone | 100 | 2-Ethyl-3-methylbutanal | 10 | 1.0E−01 | 50 | 5.57 |
| Example 53 | Balance | 5-Methyl-2-hexanone | 1 | 2-Ethyl-3-methylbutanal | 10 | 1.0E+01 | 100 | 6.27 |
| Example 54 | Balance | 5-Methyl-2-hexanone | 1 | 2-Ethyl-3-methylbutanal | 100 | 1.0E+02 | 500 | 4.61 |
| Example 55 | Balance | 5-Methyl-2-hexanone | 1 | 2-Ethyl-3-methylbutanal | 1000 | 1.0E+03 | 1000 | 3.31 |
| Example 56 | Balance | 3-Heptanone | 0.25 | NONE | — | — | 1 | 9.91 |
| Example 57 | Balance | 3-Heptanone | 0.5 | NONE | — | — | 5 | 8.91 |
| Example 58 | Balance | 3-Heptanone | 1 | NONE | — | — | 10 | 8.31 |
| Example 59 | Balance | 3-Heptanone | 100 | NONE | — | — | 50 | 5.61 |
| Example 60 | Balance | 3-Heptanone | 100 | NONE | — | — | 100 | 5.31 |
| Example 61 | Balance | 3-Heptanone | 500 | NONE | — | — | 500 | 3.91 |
| Example 62 | Balance | 3-Heptanone | 1000 | NONE | — | — | 1000 | 3.31 |
| Example 63 | Balance | 2-Methylhexanal | 0.25 | NONE | — | — | 1 | 9.91 |
| Example 64 | Balance | 2-Methylhexanal | 0.5 | NONE | — | — | 5 | 8.91 |
| Example 65 | Balance | 2-Methylhexanal | 1 | NONE | — | — | 10 | 8.31 |
| Example 66 | Balance | 2-Methylhexanal | 100 | NONE | — | — | 50 | 5.61 |
| Example 67 | Balance | 2-Methylhexanal | 100 | NONE | — | — | 100 | 5.31 |
| Example 68 | Balance | 2-Methylhexanal | 500 | NONE | — | — | 500 | 3.91 |
| Example 69 | Balance | 2-Methylhexanal | 1000 | NONE | — | — | 1000 | 3.31 |
| Example 70 | Balance | 5-Methyl-3-hexanone | 0.25 | NONE | — | — | 1 | 9.91 |
| Example 71 | Balance | 5-Methyl-3-hexanone | 0.5 | NONE | — | — | 5 | 8.91 |
| Example 72 | Balance | 5-Methyl-3-hexanone | 1 | NONE | — | — | 10 | 8.31 |
| Example 73 | Balance | 5-Methyl-3-hexanone | 100 | NONE | — | — | 50 | 5.61 |
| Example 74 | Balance | 5-Methyl-3-hexanone | 100 | NONE | — | — | 100 | 5.31 |
| Example 75 | Balance | 5-Methyl-3-hexanone | 500 | NONE | — | — | 500 | 3.91 |
| Example 76 | Balance | 5-Methyl-3-hexanone | 1000 | NONE | — | — | 1000 | 3.31 |
| Example 77 | Balance | 2-Ethyl-3-methylbutanal | 0.25 | NONE | — | — | 1 | 9.91 |
| Example 78 | Balance | 2-Ethyl-3-methylbutanal | 0.5 | NONE | — | — | 5 | 8.91 |
| Example 79 | Balance | 2-Ethyl-3-methylbutanal | 1 | NONE | — | — | 10 | 8.31 |
| Example 80 | Balance | 2-Ethyl-3-methylbutanal | 100 | NONE | — | — | 50 | 5.61 |
| Example 81 | Balance | 2-Ethyl-3-methylbutanal | 100 | NONE | — | — | 100 | 5.31 |
| Example 82 | Balance | 2-Ethyl-3-methylbutanal | 500 | NONE | — | — | 500 | 3.91 |
| Example 83 | Balance | 2-Ethyl-3-methylbutanal | 1000 | NONE | — | — | 1000 | 3.31 |

TABLE 4

| | Chemical composition of chemical solution | | | | | Evaluation of performance |
|---|---|---|---|---|---|---|
| | Cycloalkane compound | | | | | of chemical solution |
| Table 1 | | Content | Mn content | Fe content | Mn/Fe | Stain |
| (2-2) | Type | [ppm] | [ppm] | [ppm] | ratio | defects |
| Example 41 | NONE. | — | 0.03 | 0.3 | 1.0E−01 | A |
| Example 42 | NONE | — | 0.03 | 0.3 | 1.0E−01 | A |
| Example 43 | NONE | — | 0.03 | 0.3 | 1.0E−01 | A |
| Example 44 | NONE | — | 0.03 | 0.3 | 1.0E−01 | B |
| Example 45 | NONE | — | 0.03 | 0.3 | 1.0E−01 | C |
| Example 46 | NONE | — | 0.03 | 0.3 | 1.0E−01 | A |
| Example 47 | NONE | — | 0.03 | 0.3 | 1.0E−01 | A |
| Example 48 | NONE | — | 0.03 | 0.3 | 1.0E−01 | A |
| Example 49 | NONE | — | 0.03 | 0.3 | 1.0E−01 | B |
| Example 50 | NONE | — | 0.03 | 0.3 | 1.0E−01 | C |
| Example 51 | NONE | — | 0.03 | 0.3 | 1.0E−01 | A |
| Example 52 | NONE | — | 0.03 | 0.3 | 1.0E−01 | A |
| Example 53 | NONE | — | 0.03 | 0.3 | 1.0E−01 | A |
| Example 54 | NONE | — | 0.03 | 0.3 | 1.0E−01 | B |
| Example 55 | NONE | — | 0.03 | 0.3 | 1.0E−01 | C |
| Example 56 | NONE | — | 0.03 | 0.3 | 1.0E−01 | A |
| Example 57 | NONE | — | 0.03 | 0.3 | 1.0E−01 | A |
| Example 58 | NONE | — | 0.03 | 0.3 | 1.0E−01 | A |
| Example 59 | NONE | — | 0.03 | 0.3 | 1.0E−01 | A |
| Example 60 | NONE | — | 0.03 | 0.3 | 1.0E−01 | A |
| Example 61 | NONE | — | 0.03 | 0.3 | 1.0E−01 | B |
| Example 62 | NONE | — | 0.03 | 0.3 | 1.0E−01 | C |
| Example 63 | NONE | — | 0.03 | 0.3 | 1.0E−01 | A |
| Example 64 | NONE | — | 0.03 | 0.3 | 1.0E−01 | A |
| Example 65 | NONE | — | 0.03 | 0.3 | 1.0E−01 | A |
| Example 66 | NONE | — | 0.03 | 0.3 | 1.0E−01 | A |
| Example 67 | NONE | — | 0.03 | 0.3 | 1.0E−01 | A |
| Example 68 | NONE | — | 0.03 | 0.3 | 1.0E−01 | B |
| Example 69 | NONE | — | 0.03 | 0.3 | 1.0E−01 | C |
| Example 70 | NONE | — | 0.03 | 0.3 | 1.0E−01 | A |
| Example 71 | NONE | — | 0.03 | 0.3 | 1.0E−01 | A |
| Example 72 | NONE | — | 0.03 | 0.3 | 1.0E−01 | A |
| Example 73 | NONE | — | 0.03 | 0.3 | 1.0E−01 | A |
| Example 74 | NONE | — | 0.03 | 0.3 | 1.0E−01 | A |
| Example 75 | NONE | — | 0.03 | 0.3 | 1.0E−01 | B |
| Example 76 | NONE | — | 0.03 | 0.3 | 1.0E−01 | C |
| Example 77 | NONE | — | 0.03 | 0.3 | 1.0E−01 | A |
| Example 78 | NONE | — | 0.03 | 0.3 | 1.0E−01 | A |
| Example 79 | NONE | — | 0.03 | 0.3 | 1.0E−01 | A |
| Example 80 | NONE | — | 0.03 | 0.3 | 1.0E−01 | A |
| Example 81 | NONE | — | 0.03 | 0.3 | 1.0E−01 | A |
| Example 82 | NONE | — | 0.03 | 0.3 | 1.0E−01 | B |
| Example 83 | NONE | — | 0.03 | 0.3 | 1.0E−01 | C |

| | Evaluation of performance of chemical solution | | | | | |
|---|---|---|---|---|---|---|
| | | | | | Capability | |
| | | | | Residual | of reducing | Defects |
| | Foreign | In-plane | Wafer | organic | contamination | derived from |
| Table 1 | material | cleanliness | bevel | substances | with organic | chemical |
| (2-2) | defects | uniformity | cleanliness | after baking | substances | solution |
| Example 41 | A | A | S | S | A | S |
| Example 42 | A | A | S | S | S | S |
| Example 43 | A | A | S | S | S | S |
| Example 44 | A | B | S | S | A | S |
| Example 45 | A | C | S | S | C | S |
| Example 46 | A | A | S | S | A | S |
| Example 47 | A | A | S | S | S | S |
| Example 48 | A | A | S | S | S | S |
| Example 49 | A | B | S | S | A | S |
| Example 50 | A | C | S | S | C | S |
| Example 51 | A | A | S | S | A | S |
| Example 52 | A | A | S | S | S | S |
| Example 53 | A | A | S | S | S | S |
| Example 54 | A | B | S | S | A | S |
| Example 55 | A | C | S | S | C | S |
| Example 56 | C | A | C | S | C | S |
| Example 57 | B | A | B | S | C | S |
| Example 58 | A | A | B | S | C | S |
| Example 59 | A | A | A | S | C | S |
| Example 60 | A | A | A | S | C | S |
| Example 61 | A | C | A | S | C | S |
| Example 62 | A | C | A | S | C | S |
| Example 63 | C | A | C | S | C | S |
| Example 64 | B | A | B | S | C | S |
| Example 65 | A | A | B | S | C | S |
| Example 66 | A | A | A | S | C | S |
| Example 67 | A | A | A | S | C | S |
| Example 68 | A | C | A | S | C | S |
| Example 69 | A | C | A | S | C | S |
| Example 70 | C | A | C | S | C | S |
| Example 71 | B | A | B | S | C | S |
| Example 72 | A | A | B | S | C | S |
| Example 73 | A | A | A | S | C | S |
| Example 74 | A | A | A | S | C | S |
| Example 75 | A | C | A | S | C | S |
| Example 76 | A | C | A | S | C | S |
| Example 77 | C | A | C | S | C | S |
| Example 78 | B | A | B | S | C | S |
| Example 79 | A | A | B | S | C | S |
| Example 80 | A | A | A | S | C | S |
| Example 81 | A | A | A | S | C | S |
| Example 82 | A | C | A | S | C | S |
| Example 83 | A | C | A | S | C | S |

TABLE 5

| | Chemical composition of chemical solution | | | | | | | |
|---|---|---|---|---|---|---|---|---|
| | | Carbonyl compound | | | | Aldehyde/ | Water | |
| Table 1 | | | Content | | Content | ketone | content | P |
| (3-1) | 2-Heptanone | Type | [ppm] | Type | [ppm] | ratio | [ppm] | value |
| Example 84 | Balance | 2-Ethylhexanal | 0.25 | NONE | — | — | 1 | 9.96 |
| Example 85 | Balance | 2-Ethylhexanal | 0.5 | NONE | — | — | 5 | 8.96 |
| Example 86 | Balance | 2-Ethylhexanal | 1 | NONE | — | — | 10 | 8.36 |
| Example 87 | Balance | 2-Ethylhexanal | 100 | NONE | — | — | 50 | 5.66 |
| Example 88 | Balance | 2-Ethylhexanal | 100 | NONE | — | — | 100 | 5.36 |
| Example 89 | Balance | 2-Ethylhexanal | 500 | NONE | — | — | 500 | 3.96 |
| Example 90 | Balance | 2-Ethylhexanal | 1000 | NONE | — | — | 1000 | 3.36 |
| Example 91 | Balance | 4-Heptanone | 100 | NONE | — | — | 50 | 5.61 |
| Example 92 | Balance | 4-Heptanone | 100 | NONE | — | — | 50 | 5.61 |
| Example 93 | Balance | 4-Heptanone | 100 | NONE | — | — | 50 | 5.61 |
| Example 94 | Balance | 4-Heptanone | 100 | NONE | — | — | 50 | 5.61 |
| Example 95 | Balance | 4-Heptanone | 100 | NONE | — | — | 50 | 5.61 |
| Example 96 | Balance | 4-Heptanone | 100 | NONE | — | — | 50 | 5.61 |
| Example 97 | Balance | 4-Heptanone | 100 | NONE | — | — | 50 | 5.61 |
| Example 98 | Balance | 4-Heptanone | 100 | NONE | — | — | 50 | 5.61 |
| Example 99 | Balance | 4-Heptanone | 100 | NONE | — | — | 50 | 5.61 |
| Example 100 | Balance | 4-Heptanone | 100 | NONE | — | — | 50 | 5.61 |
| Example 101 | Balance | 4-Heptanone | 100 | NONE | — | — | 50 | 5.61 |
| Example 102 | Balance | 4-Heptanone | 100 | NONE | — | — | 50 | 5.61 |
| Example 103 | Balance | 4-Heptanone | 100 | NONE | — | — | 50 | 5.61 |
| Example 104 | Balance | 4-Heptanone | 100 | NONE | — | — | 50 | 5.61 |
| Example 105 | Balance | 4-Heptanone | 100 | NONE | — | — | 50 | 5.61 |
| Example 106 | Balance | 4-Heptanone | 100 | NONE | — | — | 1 | 7.31 |
| Example 107 | Balance | 4-Heptanone | 100 | NONE | — | — | 5 | 6.61 |
| Example 108 | Balance | 4-Heptanone | 100 | NONE | — | — | 10 | 6.31 |
| Example 109 | Balance | 4-Heptanone | 100 | NONE | — | — | 50 | 5.61 |
| Example 110 | Balance | 4-Heptanone | 100 | NONE | — | — | 100 | 5.31 |
| Example 111 | Balance | 4-Heptanone | 100 | NONE | — | — | 500 | 4.61 |
| Example 112 | Balance | 4-Heptanone | 100 | NONE | — | — | 1000 | 4.31 |
| Comparative Example 1 | Balance | 4-Heptanone | 1 | NONE | — | — | 10000 | 5.31 |
| Comparative Example 2 | Balance | 4-Heptanone | 10000 | NONE | — | — | 1000 | 2.31 |
| Comparative Example 3 | Balance | 4-Heptanone | 0.1 | NONE | — | — | 1 | 10.31 |
| Comparative Example 4 | Balance | 4-Heptanone | 1000 | NONE | — | — | <1 | — |
| Comparative Example 5 | Balance | 5-Methyl-2-hexanone | 1 | NONE | — | — | 10000 | 5.31 |
| Comparative Example 6 | Balance | 5-Methyl-2-hexanone | 10000 | NONE | — | — | 1000 | 2.31 |
| Comparative Example 7 | Balance | 5-Methyl-2-hexanone | 0.1 | NONE | — | — | 1 | 10.31 |
| Comparative Example 8 | Balance | 5-Methyl-2-hexanone | 1000 | NONE | — | — | <1 | — |
| Comparative Example 9 | Balance | 1-Pentanal | 100 | NONE | — | — | 50 | 5.49 |
| Comparative Example 10 | Balance | Cyclopentanone | 100 | NONE | — | — | 50 | 5.48 |
| Comparative Example 11 | Balance | 2-Pentanone | 100 | NONE | — | — | 50 | 5.49 |
| Comparative Example 12 | Balance | 3-Pentanone | 100 | NONE | — | — | 50 | 5.49 |

TABLE 6

| | Chemical composition of chemical solution | | | | | Evaluation of performance |
|---|---|---|---|---|---|---|
| | Cycloalkane compound | | Mn | Fe | | of chemical solution |
| Table 1 | | Content | content | content | Mn/Fe | Stain |
| (3-2) | Type | [ppm] | [ppm] | [ppm] | ratio | defects |
| Example 84 | NONE | — | 0.03 | 0.3 | 1.0E−01 | A |
| Example 85 | NONE | — | 0.03 | 0.3 | 1.0E−01 | A |
| Example 86 | NONE | — | 0.03 | 0.3 | 1.0E−01 | A |
| Example 87 | NONE | — | 0.03 | 0.3 | 1.0E−01 | A |
| Example 88 | NONE | — | 0.03 | 0.3 | 1.0E−01 | A |
| Example 89 | NONE | — | 0.03 | 0.3 | 1.0E−01 | B |
| Example 90 | NONE | — | 0.03 | 0.3 | 1.0E−01 | C |
| Example 91 | 1-Methyl-4- | 0.01 | 0.03 | 0.3 | 1.0E−01 | A |
| | isopropylcyclohexane | | | | | |
| Example 92 | 1-Methyl-4- | 0.30 | 0.03 | 0.3 | 1.0E−01 | A |
| | isopropylcyclohexane | | | | | |
| Example 93 | 1-Methyl-4- | 0.70 | 0.03 | 0.3 | 1.0E−01 | A |
| | isopropylcyclohexane | | | | | |
| Example 94 | 1-Methyl-4- | 800 | 0.03 | 0.3 | 1.0E−01 | A |
| | isopropylcyclohexane | | | | | |
| Example 95 | 1-Methyl-4- | 1500 | 0.03 | 0.3 | 1.0E−01 | A |
| | isopropylcyclohexane | | | | | |
| Example 96 | 1-Methyl-2- | 0.01 | 0.03 | 0.3 | 1.0E−01 | A |
| | isopropylcyclohexane | | | | | |
| Example 97 | 1-Methyl-2- | 0.30 | 0.03 | 0.3 | 1.0E−01 | A |
| | isopropylcyclohexane | | | | | |
| Example 98 | 1-Methyl-2- | 0.70 | 0.03 | 0.3 | 1.0E−01 | A |
| | isopropylcyclohexane | | | | | |
| Example 99 | 1-Methyl-2- | 800 | 0.03 | 0.3 | 1.0E−01 | A |
| | isopropylcyclohexane | | | | | |
| Example 100 | 1-Methyl-2- | 1500 | 0.03 | 0.3 | 1.0E−01 | A |
| | isopropylcyclohexane | | | | | |
| Example 101 | 1-Methyl-3- | 0.01 | 0.03 | 0.3 | 1.0E−01 | A |
| | isopropylcyclohexane | | | | | |
| Example 102 | 1-Methyl-3- | 0.30 | 0.03 | 0.3 | 1.0E−01 | A |
| | isopropylcyclohexane | | | | | |
| Example 103 | 1-Methyl-3- | 0.70 | 0.03 | 0.3 | 1.0E−01 | A |
| | Isopropylcyclohexane | | | | | |
| Example 104 | 1-Methyl-3- | 800 | 0.03 | 0.3 | 1.0E−01 | A |
| | Isopropylcyclohexane | | | | | |
| Example 105 | 1-Methyl-3- | 1500 | 0.03 | 0.3 | 1.0E−01 | A |
| | sopropylcyclohexane | | | | | |
| Example 106 | NONE | — | 0.03 | 60 | 5.0E−04 | A |
| Example 107 | NONE | — | 0.03 | 30 | 1.0E−03 | A |
| Example 108 | NONE | — | 0.03 | 1.5 | 2.0E−02 | A |
| Example 109 | NONE | — | 0.03 | 0.5 | 6.0E−02 | A |
| Example 110 | NONE | — | 0.03 | 0.043 | 7.0E−01 | A |
| Example 111 | NONE | — | 0.03 | 0.03 | 1.0E+00 | B |
| Example 112 | NONE | — | 0.03 | 0.025 | 1.2E+00 | C |
| Comparative | NONE | — | 0.03 | 0.3 | 1.0E−01 | D |
| Example 1 | | | | | | |
| Comparative | NONE | — | 0.03 | 0.3 | 1.0E−01 | C |
| Example 2 | | | | | | |
| Comparative | NONE | — | 0.03 | 0.3 | 1.0E−01 | A |
| Example 3 | | | | | | |
| Comparative | NONE | — | 0.03 | 0.3 | 1.0E−01 | A |
| Example 4 | | | | | | |
| Comparative | NONE | — | 0.03 | 0.3 | 1.0E−01 | D |
| Example 5 | | | | | | |
| Comparative | NONE | — | 0.03 | 0.3 | 1.0E−01 | C |
| Example 6 | | | | | | |
| Comparative | NONE | — | 0.03 | 0.3 | 1.0E−01 | A |
| Example 7 | | | | | | |
| Comparative | NONE | — | 0.03 | 0.3 | 1.0E−01 | A |
| Example 8 | | | | | | |
| Comparative | NONE | — | 0.03 | 0.3 | 1.0E−01 | A |
| Example 9 | | | | | | |
| Comparative | NONE | — | 0.03 | 0.3 | 1.0E−01 | A |
| Example 10 | | | | | | |
| Comparative | NONE | — | 0.03 | 0.3 | 1.0E−01 | A |
| Example 11 | | | | | | |
| Comparative | NONE | — | 0.03 | 0.3 | 1.0E−01 | A |
| Example 12 | | | | | | |

| | Evaluation of performance of chemical solution | | | | | |
|---|---|---|---|---|---|---|
| | | | | | Capability of | |
| | | | | Residual | reducing | Defects |
| | Foreign | In-plane | Wafer | organic | contamination | derived from |
| Table 1 | material | cleanliness | bevel | substances | with organic | chemical |
| (3-2) | defects | uniformity | cleanliness | after baking | substances | solution |
| Example 84 | C | A | C | S | C | S |
| Example 85 | B | A | B | S | C | S |
| Example 86 | A | A | B | S | C | S |
| Example 87 | A | A | A | S | C | S |
| Example 88 | A | A | A | S | C | S |
| Example 89 | A | C | A | S | C | S |
| Example 90 | A | C | A | S | C | S |
| Example 91 | A | A | S | S | B | S |
| Example 92 | A | A | S | S | A | S |
| Example 93 | A | A | S | S | S | S |
| Example 94 | A | A | S | B | SS | S |
| Example 95 | A | A | S | C | SS | S |
| Example 96 | A | A | S | S | B | S |
| Example 97 | A | A | S | S | A | S |
| Example 98 | A | A | S | S | S | S |
| Example 99 | A | A | S | B | SS | S |
| Example 100 | A | A | S | C | SS | S |
| Example 101 | A | A | S | S | C | S |
| Example 102 | A | A | S | S | B | S |
| Example 103 | A | A | S | S | A | S |
| Example 104 | A | A | S | B | S | S |
| Example 105 | A | A | S | C | S | S |
| Example 106 | C | A | S | S | C | C |
| Example 107 | B | A | S | S | C | B |
| Example 108 | A | A | S | S | C | A |
| Example 109 | A | A | S | S | C | S |
| Example 110 | A | A | S | S | C | B |
| Example 111 | A | B | S | S | C | B |
| Example 112 | A | B | S | S | C | C |
| Comparative | A | A | S | S | C | S |
| Example 1 | | | | | | |
| Comparative | A | D | S | S | C | S |
| Example 2 | | | | | | |
| Comparative | C | A | D | S | C | S |
| Example 3 | | | | | | |
| Comparative | D | A | S | S | C | S |
| Example 4 | | | | | | |
| Comparative | A | A | S | S | C | S |
| Example 5 | | | | | | |
| Comparative | A | D | S | S | C | S |
| Example 6 | | | | | | |
| Comparative | C | A | D | S | C | S |
| Example 7 | | | | | | |
| Comparative | D | A | S | S | C | S |
| Example 8 | | | | | | |
| Comparative | A | D | D | S | C | S |
| Example 9 | | | | | | |
| Comparative | A | D | D | S | C | S |
| Example 10 | | | | | | |
| Comparative | A | D | D | S | C | S |
| Example 11 | | | | | | |
| Comparative | A | D | D | S | C | S |
| Example 12 | | | | | | |

As can be seen from the results shown in the tables, in the chemical solutions of the invention produced in Examples 1 to 112, the effects of the invention are higher than those of the chemical solutions in Comparative Examples 1 and 5 in which the content of water is more than 10000 ppt by mass, those of the chemical solutions in Comparative Examples 2, 3, 6, and 7 in which the P value is less than 3 or more than 10, those of the chemical solutions in Comparative Examples 4 and 8 in which the content of water is less than 1 ppt by mass, and those of the chemical solutions in Comparative Examples 9 to 12 containing no specific carbonyl compound.

As can be seen by comparing Examples 1 to 4 etc., when the P value is 9 or less, the number of foreign defects can be further reduced, and the wafer bevel cleanliness can be further improved. When the P value is 8.5 or less, the number of foreign defects can be still further reduced. When the P value is 8 or less, the wafer bevel cleanliness can be still further improved.

As can be seen by comparing Examples 4 to 7 etc., when the P value is 3.5 or more, the number of stain-like defects can be further reduced. When P value is 5 or more, the number of stain-like defects can be still further reduced, and the in-plane cleanliness uniformity is further improved.

As can be seen by comparing Examples 38 to 40 etc., when the ratio of the content of the specific aldehyde to the content of the specific ketone in the chemical solution is 1.0×10² or less, the effects of the invention are further enhanced. When the ratio is 1.0×10¹ or less, the effects of the invention are still further enhanced.

As can be seen by comparing Examples 11 and 91 to 93 etc., when the content of the specific cycloalkane compound is 0.3 ppm by mass or more based on the total mass of the chemical solution, the effect of reducing the contamination with organic substances after the wafer is washed is high. When the content of the specific cycloalkane compound is 0.5 ppm by mass or more, the effect of reducing the contamination with organic substances after the wafer is washed is higher. When the content of the specific cycloalkane compound is 1.0 ppm by mass or more, the effect of reducing the contamination with organic substances after the wafer is washed is still higher.

As can be seen by comparing Examples 11, 94, and 95 etc., when the content of the specific cycloalkane compound is 1000 ppm by mass or less based on the total mass of the chemical solution, the effect of reducing the amount of organic substances derived from the chemical solution on the baked silicon wafer is high. When the content of the specific cycloalkane compound is 700 ppm by mass or less, the effect of reducing the amount of organic substances derived from the chemical solution on the baked silicon wafer is higher.

As can be seen by comparing Examples 106 to 109, when the ratio (Mn/Fe ratio) of the content of Mn atoms to the content of Fe atoms in the chemical solution is 1.0×10⁻³ or more, the effects of the invention and the effect of preventing the occurrence of defects derived from the chemical solution are further enhanced. When the Mn/Fe ratio is 1.0×10⁻² or more, the effects of the invention and the effect of preventing the occurrence of defects derived from the chemical solution are still further enhanced. When the Mn/Fe ratio is 5.0×10⁻² or more, the effect of preventing the occurrence of defects derived from the chemical solution is particularly enhanced.

As can be seen by comparing Examples 110 to 112, when the Mn/Fe ratio is 1.0 or less, the effects of the invention and the effect of preventing the occurrence of defects derived from the chemical solution are further enhanced. When the Mn/Fe ratio is 7.0×10⁻¹ or less, the effects of the invention are still further enhanced. When the Mn/Fe ratio is 5.0×10⁻¹ or less, the effect of preventing the occurrence of defects derived from the chemical solution is still further enhanced.

What is claimed is:

1. A chemical solution comprising: 2-heptanone; water; and a carbonyl compound having 6 to 8 carbon atoms other than 2-heptanone,
wherein a content of the 2-heptanone is 60% by mass or more based on a total mass of the chemical solution,
wherein a content of the water is 1 to 1000 ppm by mass based on the total mass of the chemical solution, and
wherein a P value determined from the following formula (1) is 3 to 10:
$$P = - {log}_{10} ( X \times Y ) , \qquad formula ( 1 )$$
where X is a numerical value X when a concentration of the water in the chemical solution is denoted by X mol/L, and Y is a numerical value Y when a concentration of the carbonyl compound in the chemical solution is denoted by Y mol/L.

2. The chemical solution according to claim 1, wherein the content of the water is 1 to 100 ppm by mass based on the total mass of the chemical solution.

3. The chemical solution according to claim 1, wherein a content of the carbonyl compound is 0.1 to 1000 ppm by mass based on the total mass of the chemical solution.

4. The chemical solution according to claim 1, wherein the carbonyl compound includes a ketone having 6 to 8 carbon atoms other than 2-heptanone.

5. The chemical solution according to claim 1, wherein the carbonyl compound includes two or more ketones having 6 to 8 carbon atoms other than 2-heptanone.

6. The chemical solution according to claim 1, wherein the carbonyl compound includes at least one selected from the group consisting of 5-methyl-2-hexanone and 4-heptanone.

7. The chemical solution according to claim 1, wherein the carbonyl compound includes a carbonyl compound represented by a chemical formula C₇H₁₄O.

8. The chemical solution according to claim 1, wherein the carbonyl compound includes a ketone having 6 to 8 carbon atoms other than 2-heptanone and an aldehyde having 6 to 8 carbon atoms, and
wherein a ratio of a content of the aldehyde to a content of the ketone is 1.0×10⁻⁵ to 1.0×10².

9. The chemical solution according to claim 4, further comprising a cycloalkane compound having 8 to 12 carbon atoms and having a boiling point of 160° C. or higher,
wherein a content of the cycloalkane compound is 0.1 to 1000 ppm by mass based on the total mass of the chemical solution.

10. The chemical solution according to claim 9, wherein the cycloalkane compound includes at least one selected from the group consisting of 1-methyl-2-isopropylcyclohexane, 1-methyl-3-isopropylcyclohexane, and 1-methyl-4-isopropylcyclohexane.

11. The chemical solution according to claim 9, wherein the cycloalkane compound includes 1-methyl-4-isopropylcyclohexane.

12. The chemical solution according to claim 1, further comprising Mn atoms,
wherein a content of the Mn atoms is 0.001 to 10 ppt by mass based on the total mass of the chemical solution.

13. The chemical solution according to claim 1, further comprising Mn atoms and Fe atoms,
wherein a ratio of a content of the Mn atoms to a content of the Fe atoms is 1.0×10⁻³ to

1. 0.

14. The chemical solution according to claim 1, wherein the chemical solution is used as at least one selected from the group consisting of a washing liquid, a developer, a pre-wetting liquid, and a rinsing liquid.

15. The chemical solution according to claim 1, wherein the chemical solution is used as at least one selected from the group consisting of a pre-wetting liquid, a rinsing liquid, a washing liquid, and a developer in a semiconductor substrate production process including the step of forming a metal resist film.

16. A chemical solution-housing article comprising: a container; and the chemical solution according to claim 1, the chemical solution being housed in the container.

17. The chemical solution-housing article according to claim 16, wherein the container has a liquid-contacting portion that is in contact with the chemical solution and that is formed of a nonmetallic material or stainless steel.

18. The chemical solution-housing article according to claim 16, wherein the nonmetallic material is at least one selected from the group consisting of polyethylene resins, polypropylene resins, polyethylene-polypropylene resins, tetrafluoroethylene resins, tetrafluoroethylene-perfluoroalkyl vinyl ether copolymers, tetrafluoroethylene-hexafluoropropylene copolymer resins, tetrafluoroethylene-ethylene copolymer resins, chlorotrifluoroethylene-ethylene copolymer resins, vinylidene fluoride resins, chlorotrifluoroethylene copolymer resins, and vinyl fluoride resins.

19. The chemical solution according to claim 2, wherein a content of the carbonyl compound is 0.1 to 1000 ppm by mass based on the total mass of the chemical solution.

20. The chemical solution according to claim 2, wherein the carbonyl compound includes a ketone having 6 to 8 carbon atoms other than 2-heptanone.
